(19) United States
(12) Patent Application Publication
(10) Pub. No.: US 2024/0154726 A1
(43) Pub. Date: May 9, 2024

(54) TECHNIQUES FOR TRANSMITTING A SCHEDULING REQUEST FOR PENDING HYBRID AUTOMATIC REPEAT REQUEST BITS

(71) Applicant: QUALCOMM Incorporated, San Diego, CA (US)

(72) Inventors: Konstantinos DIMOU, New York, NY (US); Peter GAAL, San Diego, CA (US); Jae Ho RYU, San Diego, CA (US); Yan ZHOU, San Diego, CA (US); Tao LUO, San Diego, CA (US)

(21) Appl. No.: 18/552,640

(22) PCT Filed: May 23, 2022
(86) PCT No.: PCT/US2022/030523

§ 371 Date: Sep. 26, 2023

(30) Foreign Application Priority Data
May 25, 2021 (GR) 20210100343

(51) Int. Cl. H04L 1/1812; H04W 72/12; H04W 72/21; H04W 74/0833

(52) U.S. Cl. CPC H04L 1/1812; H04W 72/12; H04W 72/21; H04W 74/0833

(57) ABSTRACT

Methods, systems, and devices for wireless communications are described. In some systems, a user equipment (UE) may accumulate a number of hybrid automatic repeat request (HARQ) bits as a result of one or more resource conflicts and may store the number of HARQ bits for a later transmission opportunity. The UE may transmit a scheduling request that requests resources for a transmission of the number of HARQ bits that are stored at the UE as a result of the number of HARQ bits satisfying a triggering condition. For example, the UE may transmit the scheduling request if a quantity of the number of HARQ bits satisfies a threshold quantity. Additionally or alternatively, the UE may transmit the scheduling request if the number of HARQ bits include triggering content. For example, the UE may transmit the scheduling request if any HARQ bit stored at the UE conveys a negative acknowledgement (NACK).

### CROSS REFERENCE

The present application is a 371 national stage filing of International PCT Application No. PCT/US2022/030523 by DIMOU et al. entitled “TECHNIQUES FOR TRANSMITTING A SCHEDULING REQUEST FOR PENDING HYBRID AUTOMATIC REPEAT REQUEST BITS,” filed May 23, 2022; and claims priority to Greek Patent Application No. 20210100343 by DIMOU et al., entitled “TECHNIQUES FOR TRANSMITTING A SCHEDULING REQUEST FOR PENDING HYBRID AUTOMATIC REPEAT REQUEST BITS,” filed May 25, 2021, each of which is assigned to the assignee hereof, and each of which is expressly incorporated by reference in its entirety herein.

### TECHNICAL FIELD

The following relates to wireless communications, including techniques for transmitting a scheduling request for pending hybrid automatic repeat request (HARQ) bits.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some systems, a UE may be configured or indicated to provide feedback to a network device, such as a base station, responsive to a downlink transmission. For example, the UE may receive and attempt to decode the downlink transmission and may transmit feedback signaling, to the network device, indicating whether the decoding was successful.

### SUMMARY

The described techniques relate to improved methods, systems, devices, and apparatuses that support techniques for transmitting a scheduling request for pending hybrid automatic repeat request (HARQ) bits. Generally, the described techniques provide for improved feedback processes, effectively increasing the likelihood that a user equipment (UE) provides feedback information (e.g., HARQ bits) in a timely manner (e.g., within a specific time window). The described techniques use a scheduling request that is dedicated for requesting resources for transmission of feedback information (e.g., HARQ bits) that is stored at a UE. For example, as a result of slot format changes, insufficient resources, or one or more cancellation indications, the UE may accumulate a number of HARQ bits that are stored at the UE and pending transmission. In some examples, the UE may request resources over which to transmit the HARQ bits if the HARQ bits stored at the UE satisfy a triggering condition.

Such a triggering condition may include a threshold quantity of HARQ bits or may be related to a content of the HARQ bits. For instance, in examples in which the triggering condition is based on a threshold quantity of HARQ bits, the UE may transmit the scheduling request as a result of storing a quantity of HARQ bits that is greater than or equal to the threshold quantity. Additionally, or alternatively, in examples in which the triggering condition is based on a content of the stored HARQ bits, the UE may transmit the scheduling request as a result of storing HARQ bits associated with or conveying the triggering content. In some examples, the triggering content may be or refer to a negative acknowledgement (NACK), and the UE may transmit the scheduling request if any HARQ bit stored by the UE conveys information relating to a NACK.

A method for wireless communication at a UE is described. The method may include storing, at the UE, one or more HARQ bits associated with one or more HARQ process identifiers of the UE, transmitting a scheduling request associated with the one or more HARQ based on a quantity of the one or more HARQ bits, receiving, responsive to the scheduling request, control signaling indicating an uplink resource allocation for a transmission of the one or more HARQ bits, and transmitting the one or more HARQ bits over the uplink resource allocation.

An apparatus for wireless communication at a UE is described. The apparatus may include at least one processor, memory coupled (e.g., operatively, communicatively, functionally, electronically, or electrically) with the at least one processor, and instructions stored in the memory. The instructions may be executable by the at least one processor to cause the UE to store, at the UE, one or more HARQ bits associated with one or more HARQ process identifiers of the UE, transmit a scheduling request associated with the one or more HARQ bits based on a quantity of the one or more HARQ bits, receive, responsive to the scheduling request, control signaling indicating an uplink resource allocation for a transmission of the one or more HARQ bits, and transmit the one or more HARQ bits over the uplink resource allocation.

Another apparatus for wireless communication at a UE is described. The apparatus may include means for storing, at the UE, one or more HARQ bits associated with one or more HARQ process identifiers of the UE, means for transmitting a scheduling request associated with the one or more HARQ bits based on a quantity of the one or more HARQ bits, means for receiving, responsive to the scheduling request, control signaling indicating an uplink resource allocation for a transmission of the one or more HARQ bits, and means for transmitting the one or more HARQ bits over the uplink resource allocation.

A non-transitory computer-readable medium storing code for wireless communication at a UE is described. The code may include instructions executable by at least one processor to store, at the UE, one or more HARQ bits associated with one or more HARQ process identifiers of the UE, transmit a scheduling request associated with the one or more HARQ bits based on a quantity of the one or more HARQ bits, receive, responsive to the scheduling request, control signaling indicating an uplink resource allocation for a transmission of the one or more HARQ bits, and transmit the one or more HARQ bits over the uplink resource allocation.

Some examples of the method, apparatuses, and non-transitory computer-readable medium described herein may further include operations, features, means, or instructions for triggering the scheduling request as a result of the quantity of the one or more HARQ bits stored at the UE satisfying a triggering condition, where the scheduling request is transmitted based on the triggering.

In some examples of the method, apparatuses, and non-transitory computer-readable medium described herein, the triggering condition includes a threshold quantity of HARQ bits stored at the UE. In some examples, at least one HARQ bit may be stored at the UE, and the scheduling request may be transmitted based on the UE storing the at least one HARQ bit (e.g., the threshold quantity of HARQ bits may be one HARQ bit).

In some examples of the method, apparatuses, and non-transitory computer-readable medium described herein, the one or more HARQ bits include at least one bit that is associated with NACK feedback and the one or more HARQ bits satisfying the triggering condition is based on the one or more HARQ bits including the at least one bit that is associated with the NACK feedback.

In some examples of the method, apparatuses, and non-transitory computer-readable medium described herein, transmitting the one or more HARQ bits over the uplink resource allocation may include operations, features, means, or instructions for including the scheduling request associated with the one or more HARQ bits in uplink control information (UCI) in accordance with a priority of scheduling requests associated with HARQ bits stored at the UE.

Some examples of the method, apparatuses, and non-transitory computer-readable medium described herein may further include operations, features, means, or instructions for transmitting, to a network device (e.g., a base station or other network entity), a random access message associated with a random access procedure based on the quantity of the one or more HARQ bits and the UE being in an unconnected state and establishing a connection with the network device as a result of the random access procedure, where transmitting the scheduling request associated with the one or more HARQ bits may be based on establishing the connection with the network device.

In some examples of the method, apparatuses, and non-transitory computer-readable medium described herein, receiving the control signaling indicating the uplink resource allocation may include operations, features, means, or instructions for receiving an indication of the one or more HARQ process identifiers for which feedback may be requested, where transmitting the one or more HARQ bits associated with the one or more HARQ process identifiers may be based on the indication of the one or more HARQ process identifiers for which feedback may be requested.

In some examples of the method, apparatuses, and non-transitory computer-readable medium described herein, transmitting the scheduling request associated with the one or more HARQ bits may include operations, features, means, or instructions for transmitting UCI including one or more bits indicating the scheduling request, the one or more bits having a location in the UCI that may be dedicated for scheduling requests associated with HARQ bits stored at the UE.

In some examples of the method, apparatuses, and non-transitory computer-readable medium described herein, the location in the UCI includes a field dedicated for the scheduling requests associated with HARQ bits stored at the UE.

Some examples of the method, apparatuses, and non-transitory computer-readable medium described herein may further include operations, features, means, or instructions for receiving signaling indicating a configuration of resources for the scheduling request, where the resources may be exclusively for scheduling requests associated with HARQ bits stored at the UE in accordance with the configuration, and where the scheduling request associated with the one or more HARQ bits may be transmitted over the resources.

In some examples of the method, apparatuses, and non-transitory computer-readable medium described herein, the uplink resource allocation includes a physical uplink control channel (PUCCH) and receiving the control signaling indicating the uplink resource allocation may include operations, features, means, or instructions for receiving an indication of a PUCCH format associated with the PUCCH, where the scheduling request associated with the one or more HARQ bits may be transmitted using the PUCCH format.

In some examples of the method, apparatuses, and non-transitory computer-readable medium described herein, the uplink resource allocation includes a physical uplink shared channel (PUSCH) and the method, apparatuses, and non-transitory computer-readable medium may include further operations, features, means, or instructions for multiplexing the one or more HARQ bits with a data transmission over the PUSCH, where transmitting the one or more HARQ bits over the PUSCH may be based on the multiplexing.

Some examples of the method, apparatuses, and non-transitory computer-readable medium described herein may further include operations, features, means, or instructions for multiplexing the scheduling request associated with the one or more HARQ bits with one or more other feedback bits over a PUCCH based on applying an identifier-specific phase shift, where transmitting the scheduling request associated with the one or more HARQ bits may be based on the multiplexing.

Some examples of the method, apparatuses, and non-transitory computer-readable medium described herein may further include operations, features, means, or instructions for starting a timer as a result of transmitting the scheduling request associated with the one or more HARQ bits and refraining from transmitting another scheduling request associated with HARQ bits stored at the UE for a duration of the timer.

Some examples of the method, apparatuses, and non-transitory computer-readable medium described herein may further include operations, features, means, or instructions for failing to transmit the one or more HARQ bits via previous UCI signaling based on one or more of a slot format change, an insufficiency of resources, or a cancellation indication and deferring the one or more HARQ bits for later UCI signaling, where storing the one or more HARQ bits at the UE may be based on the deferring.

Another method for wireless communication is described. The method may include receiving a scheduling request associated with one or more HARQ bits for a UE based on a quantity of the one or more HARQ bits, the one or more HARQ bits being associated with one or more HARQ process identifiers of the UE, transmitting, responsive to the scheduling request, control signaling indicating an uplink resource allocation for a transmission of the one or more HARQ bits, and receiving the one or more HARQ bits over the uplink resource allocation.

An apparatus for wireless communication at a network device is described. The apparatus may include at least one processor, memory coupled (e.g., operatively, communicatively, functionally, electronically, or electrically) with the at least one processor, and instructions stored in the memory. The instructions may be executable by the at least one processor to cause the network device to receive a scheduling request associated with one or more HARQ bits for a UE based on a quantity of the one or more HARQ bits, the one or more HARQ bits being associated with one or more HARQ process identifiers of the UE, transmit, responsive to the scheduling request, control signaling indicating an uplink resource allocation for a transmission of the one or more HARQ bits, and receive the one or more HARQ bits over the uplink resource allocation.

Another apparatus for wireless communication is described. The apparatus may include means for receiving a scheduling request associated with one or more HARQ bits for a UE based on a quantity of the one or more HARQ bits, the one or more HARQ bits being associated with one or more HARQ process identifiers of the UE, means for transmitting, responsive to the scheduling request, control signaling indicating an uplink resource allocation for a transmission of the one or more HARQ bits, and means for receiving the one or more HARQ bits over the uplink resource allocation.

A non-transitory computer-readable medium storing code for wireless communication at a base station is described. The code may include instructions executable by at least one processor to receive a scheduling request associated with one or more HARQ bits for a UE based on a quantity of the one or more HARQ bits, the one or more HARQ bits being associated with one or more HARQ process identifiers of the UE, transmit, responsive to the scheduling request, control signaling indicating an uplink resource allocation for a transmission of the one or more HARQ bits, and receive the one or more HARQ bits over the uplink resource allocation.

In some examples of the method, apparatuses, and non-transitory computer-readable medium described herein, receiving the scheduling request associated with the one or more HARQ bits may include operations, features, means, or instructions for receiving UCI including the scheduling request associated with the one or more HARQ bits in accordance with a priority of scheduling requests associated with HARQ bits stored at the UE.

Some examples of the method, apparatuses, and non-transitory computer-readable medium described herein may further include operations, features, means, or instructions for receiving a random access message associated with a random access procedure based on the quantity of the one or more HARQ bits for the UE and the UE being in an unconnected state and establishing a connection with the UE as a result of the random access procedure, where receiving the scheduling request associated with the one or more HARQ bits may be based on establishing the connection with the UE.

In some examples of the method, apparatuses, and non-transitory computer-readable medium described herein, transmitting the control signaling indicating the uplink resource allocation may include operations, features, means, or instructions for transmitting an indication of the one or more HARQ process identifiers for which feedback is requested, where receiving the one or more HARQ bits associated with the one or more HARQ process identifiers may be based on the indication of the one or more HARQ process identifiers for which feedback is requested.

In some examples of the method, apparatuses, and non-transitory computer-readable medium described herein, receiving the scheduling request associated with the one or more HARQ bits may include operations, features, means, or instructions for receiving UCI including one or more bits indicating the scheduling request, the one or more bits having a location in the UCI that may be dedicated for scheduling requests associated with HARQ bits stored at the UE.

In some examples of the method, apparatuses, and non-transitory computer-readable medium described herein, the location in the UCI includes a field dedicated for the scheduling requests associated with HARQ bits stored at the UE.

Some examples of the method, apparatuses, and non-transitory computer-readable medium described herein may further include operations, features, means, or instructions for transmitting signaling indicating a configuration of resources for the scheduling request, where the resources may be exclusively for scheduling requests associated with HARQ bits stored at the UE in accordance with the configuration, and where the scheduling request associated with the one or more HARQ bits may be received over the resources.

In some examples of the method, apparatuses, and non-transitory computer-readable medium described herein, the scheduling request associated with the one or more HARQ bits may be received based on the quantity of the one or more HARQ bits satisfying a threshold quantity of HARQ bits stored at the UE.

In some examples of the method, apparatuses, and non-transitory computer-readable medium described herein, the one or more HARQ bits include at least one bit that is associated with NACK feedback, the one or more HARQ bits satisfy a triggering condition based on the one or more HARQ bits including the at least one bit that is associated with the NACK feedback, and the scheduling request associated with the one or more HARQ bits may be received based on the one or more HARQ bits satisfying the triggering condition.

In some examples of the method, apparatuses, and non-transitory computer-readable medium described herein, the uplink resource allocation includes a PUCCH, and transmitting the control signaling indicating the uplink resource allocation may include operations, features, means, or instructions for transmitting an indication of a PUCCH format associated with the PUCCH, where the scheduling request associated with the one or more HARQ bits may be received in accordance with the PUCCH format.

In some examples of the method, apparatuses, and non-transitory computer-readable medium described herein, the uplink resource allocation includes a PUSCH, and the method, apparatuses, and non-transitory computer-readable medium may include further operations, features, means, or instructions for demultiplexing the one or more HARQ bits from a data transmission over the PUSCH, where receiving the one or more HARQ bits over the PUSCH may be based on the demultiplexing.

Some examples of the method, apparatuses, and non-transitory computer-readable medium described herein may further include operations, features, means, or instructions for demultiplexing the scheduling request associated with the one or more HARQ bits from one or more other feedback bits over a PUCCH based on an identifier-specific phase shift, where receiving the scheduling request associated with the one or more HARQ bits may be based on the demultiplexing.

### BRIEF DESCRIPTION OF THE DRAWINGS

FIGS. 1 and 2 illustrate examples of wireless communications systems that support techniques for transmitting a scheduling request for pending hybrid automatic repeat request (HARQ) bits in accordance with aspects of the present disclosure.

FIGS. 3 through 5 illustrate examples of communication timelines that support techniques for transmitting a scheduling request for pending HARQ bits in accordance with aspects of the present disclosure.

FIG. 6 illustrates an example of a process flow that supports techniques for transmitting a scheduling request for pending HARQ bits in accordance with aspects of the present disclosure.

FIGS. 7 and 8 show block diagrams of devices that support techniques for transmitting a scheduling request for pending HARQ bits in accordance with aspects of the present disclosure.

FIG. 9 shows a block diagram of a communications manager that supports techniques for transmitting a scheduling request for pending HARQ bits in accordance with aspects of the present disclosure.

FIG. 10 shows a diagram of a system including a device that supports techniques for transmitting a scheduling request for pending HARQ bits in accordance with aspects of the present disclosure.

FIGS. 11 and 12 show block diagrams of devices that support techniques for transmitting a scheduling request for pending HARQ bits in accordance with aspects of the present disclosure.

FIG. 13 shows a block diagram of a communications manager that supports techniques for transmitting a scheduling request for pending HARQ bits in accordance with aspects of the present disclosure.

FIG. 14 shows a diagram of a system including a device that supports techniques for transmitting a scheduling request for pending HARQ bits in accordance with aspects of the present disclosure.

FIGS. 15 through 18 show flowcharts illustrating methods that support techniques for transmitting a scheduling request for pending HARQ bits in accordance with aspects of the present disclosure.

### DETAILED DESCRIPTION

In some wireless communications systems, a user equipment (UE) may be configured to provide feedback, such as hybrid automatic repeat request (HARQ) feedback, responsive to one or more downlink transmissions. For example, a base station, which in some cases may be an example of a network device or a network entity, may transmit a downlink transmission (e.g., a downlink data transmission) and the UE may attempt to decode the downlink transmission. In accordance with whether the UE is able to successfully decode the downlink transmission, the UE may either transmit positive acknowledgement (ACK) feedback or negative acknowledgement (NACK) feedback to the base station to indicate whether the decoding was successful. In some cases, however, the UE may be unable to transmit feedback to the base station as a result of a resource conflict.

For example, the UE may schedule a feedback transmission to the base station over a set of resources (e.g., a set of one or more symbols) and, in some cases, the UE may be unable to send the feedback transmission over the set of resources as a result of a slot format change (e.g., if the set of resources conflict with symbols that are configured for downlink), an insufficiency of resources (e.g., if the UE is requested to transmit other uplink signaling over the set of resources), or if the UE receives a cancellation indication associated with the set of resources (e.g., if the set of resources are re-allocated for other signaling within the system). In some systems, such as in relatively highly congested systems, it is possible that the UE may experience one or more of such resource conflicts multiple times (e.g., consecutively), such that the UE may progressively store more and more feedback at the UE. In some cases, such storage of feedback at the UE may adversely impact system coordination and scheduling decisions, as the network may be unaware of whether signaling is being successfully received at the UE for relatively long durations of time.

In some examples of the present disclosure, the UE may transmit, to the network (e.g., via a network device, such as a base station or other network entity), a scheduling request that requests resources for transmission of feedback information (e.g., HARQ bits) that is stored at the UE. The scheduling request may be associated with a type of scheduling request that is dedicated for requesting resources for feedback transmissions and may be included within uplink control information (UCI) as one or more bits or in a dedicated field. In some examples, the UE may transmit the scheduling request as a result of satisfying a triggering condition. For example, the UE may transmit the scheduling request if a quantity of HARQ bits stored at the UE satisfies a threshold quantity of HARQ bits. Additionally, or alternatively, the UE may transmit the scheduling request if a content of the HARQ bits stored at the UE satisfies a condition (e.g., if any HARQ bits stored at the UE convey information relating to a NACK). In some examples, the UE may receive control signaling, from the network (e.g., via a network device, such as a base station or other network entity) and responsive to the scheduling request, indicating an uplink resource allocation over which the UE may transmit the HARQ bits that are stored at the UE. Accordingly, the UE may transmit the stored HARQ bits to the network over the indicated uplink resource allocation.

Particular aspects of the subject matter described in this disclosure can be implemented to realize one or more of the following potential advantages. For example, the described techniques may be implemented to provide feedback in a more reliable manner and with lower latency as a result of the described signaling mechanism for requesting resources over which to transmit the feedback based on one or both of a quantity of HARQ bits that are pending transmission or a content of the pending HARQ bits. Further, in accordance with some examples of the present disclosure, the UE may store an upper limit of HARQ bits prior to transmitting the scheduling request, which may limit the impact that storing HARQ bits at the UE has on an available memory space of the UE. Further, as a result of providing feedback in a more reliable manner and with lower latency, the UE or the network, or both, may experience greater system coordination and make improved scheduling decisions based on the feedback from the UE, which may increase the likelihood for successful communication between the UE and the network. Accordingly, the UE and the network may achieve greater system throughput, higher data rates, and greater spectral efficiency.

Aspects of the disclosure are initially described in the context of wireless communications systems. Additionally, aspects of the disclosure are illustrated by and described with reference to communication timelines and a process flow. Aspects of the disclosure are further illustrated by and described with reference to apparatus diagrams, system diagrams, and flowcharts that relate to techniques for transmitting a scheduling request for pending HARQ bits.

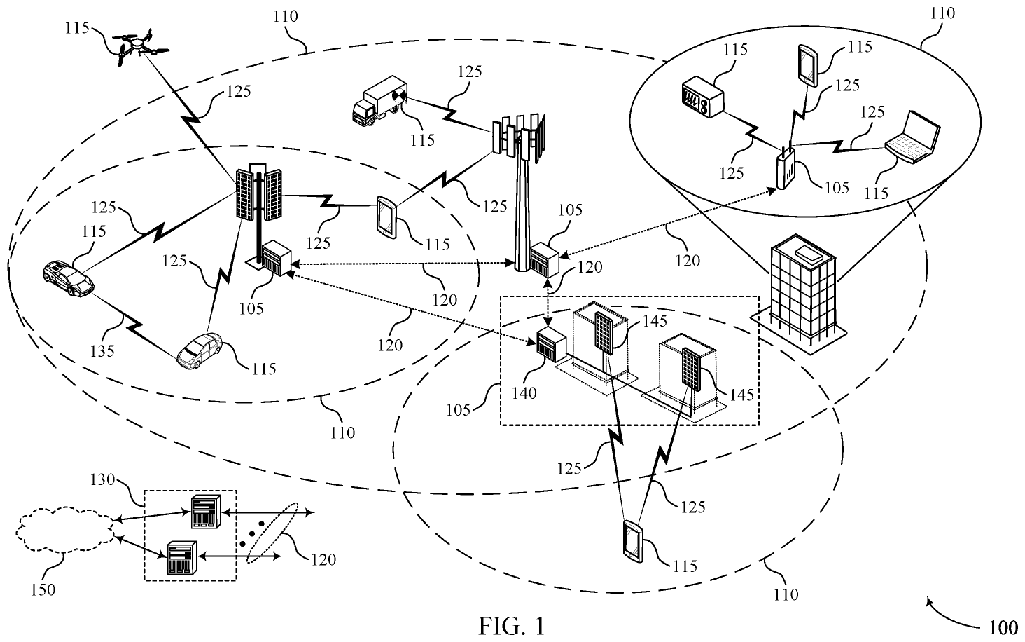

FIG. 1 illustrates an example of a wireless communications system 100 that supports techniques for transmitting a scheduling request for pending HARQ bits in accordance with aspects of the present disclosure. The wireless communications system 100 may include one or more base stations 105, which in some examples may be referred to as one or more network devices or network entities, one or more UEs 115, and a core network 130. For example, the operations described herein with reference to a base station 105 may alternatively be performed by any network entity or system of network entities, such as the network entities described with reference to FIG. 1. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof. Components within a wireless communication system, such as the wireless communications system 100, may be coupled (for example, operatively, communicatively, functionally, electronically, and/or electrically) to each other.

Network devices, such as the base stations 105, may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a network device, a network entity, a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., global navigation satellite system (GNSS) devices based on, for example, global positioning system (GPS), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include further eMTC (FeMTC), enhanced further eMTC (eFeMTC), and massive MTC (mMTC), and NB-IoT may include enhanced NB-IoT (eNB-IoT), and further enhanced NB-IoT (FeNB-IoT).

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, sometimes in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A network device (e.g., a base station 105 or other network entity) may transmit a downlink transmission (e.g., such as a downlink data transmission) to a UE 115 and, in some cases, the UE 115 may generate feedback indicating whether the UE 115 was able to successfully decode the downlink transmission. For example, the UE 115 may generate an ACK if the UE 115 successfully decoded the downlink transmission. Alternatively, the UE 115 may generate a NACK if the UE 115 failed to successfully decode the downlink transmission. In some aspects, the UE 115 may generate the feedback conveying ACK or NACK via a number of bits, which may be referred to herein as HARQ bits. The UE 115 may plan to transmit the generated feedback (e.g., the HARQ bits) to the network device (e.g., the base station 105) over configured or indicated resources (e.g., over resources that are a number of symbols after the downlink transmission or after the control signaling scheduling the downlink transmission).

In some cases, however, the configured or indicated resources over which the UE 115 planned to transmit the feedback to the network device (e.g., the base station 105) may become unavailable for the feedback transmission as a result of a resource conflict. Such a resource conflict may include a conflict between configured uplink and downlink symbols (e.g., as a result of a slot format change), an insufficiency of resources, or a cancellation indication. In such cases, the UE 115 may refrain from transmitting the feedback and may store the generated HARQ bits (e.g., in a HARQ buffer of the UE 115, with associations with HARQ process identifiers) for later transmission. Such stored HARQ bits that were planned for earlier transmission may be referred to herein as pending HARQ bits, as such HARQ bits are pending transmission from the UE 115. In some cases, the UE 115 may experience one or multiple resource conflicts (e.g., such as multiple consecutive resource conflicts) with resources scheduled for feedback transmissions and may store a progressively greater number of HARQ bits over time.

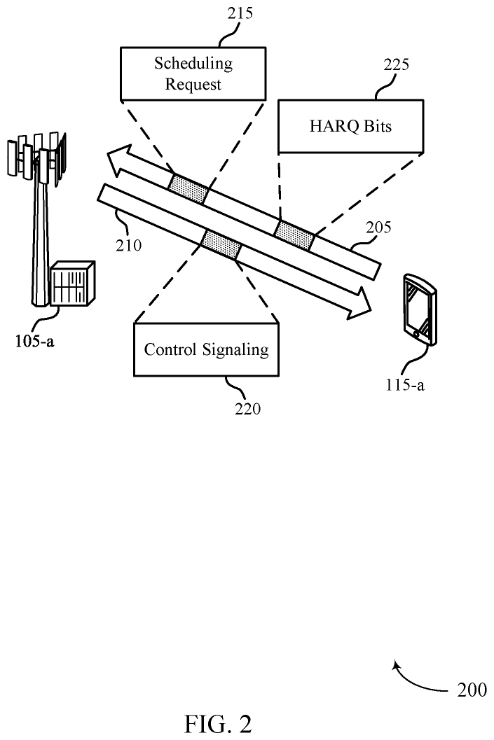

In some examples, the UE 115 may transmit a scheduling request associated with HARQ feedback to the network device (e.g., the base station 105) as a result of the HARQ bits stored at the UE 115 satisfying a triggering condition. Such a triggering condition may include or refer to a threshold quantity of HARQ bits or a content of stored HARQ bits, or both, and the UE 115 may transmit the scheduling request associated with HARQ feedback to the network device (e.g., the base station 105) via UCI. In some aspects, the scheduling request may be of a type of scheduling request that is dedicated for HARQ feedback. As such, the UE 115 may exclusively transmit such a scheduling request associated with HARQ feedback to request resources for a transmission of HARQ bits that are stored at the UE 115. Additional details relating to such a transmission of a scheduling request associated with stored or pending HARQ feedback are described herein, including with reference to FIG. 2.

FIG. 2 illustrates an example of a wireless communications system 200 that supports techniques for transmitting a scheduling request 215 for pending HARQ bits 225 in accordance with aspects of the present disclosure. The wireless communications system 200 may implement or be implemented to realize aspects of the wireless communications system 100. For example, the wireless communications system 200 may illustrate communication between a UE 115-a and a base station 105-a (e.g., a network device or other network entity), which may be examples of corresponding devices described herein, including with reference to FIG. 1. In some examples, the UE 115-a may transmit a scheduling request 215 to the base station 105-a over a communication link 205 (e.g., an uplink) requesting resources for a transmission of a number of HARQ bits 225 that are stored at the UE 115-a. In some examples, the HARQ bits 225 may include one or more HARQ bits 225. Responsive to the scheduling request 215, the base station 105-a may transmit control signaling 220 to the UE 115-a over a communication link 210 (e.g., a downlink) indicating an uplink resource allocation for the HARQ bits 225.

For example, the base station 105-a may transmit downlink signaling including one or more downlink transmissions to the UE 115-a over the communication link 210 and, in some cases, the UE 115-a may generate and attempt to transmit feedback (e.g., including the HARQ bits 225) to the base station 105-a indicating whether the one or more downlink transmissions were successfully decoded by the UE 115-a. The UE 115-a may select, determine, or otherwise identify resources (e.g., time resources or frequency resources, or both) over which to transmit the feedback to the base station 105-a based on a resource configuration or an indication included in at least one of the downlink transmissions. For example, the base station 105-a may transmit an indication of a value, which may be referred to herein as a K1 value, to the UE 115-a, and the UE 115-a may use the K1 value to select, determine, or otherwise identify a starting symbol or a slot over which to transmit the feedback (e.g., the HARQ bits 225) to the base station 105-a.

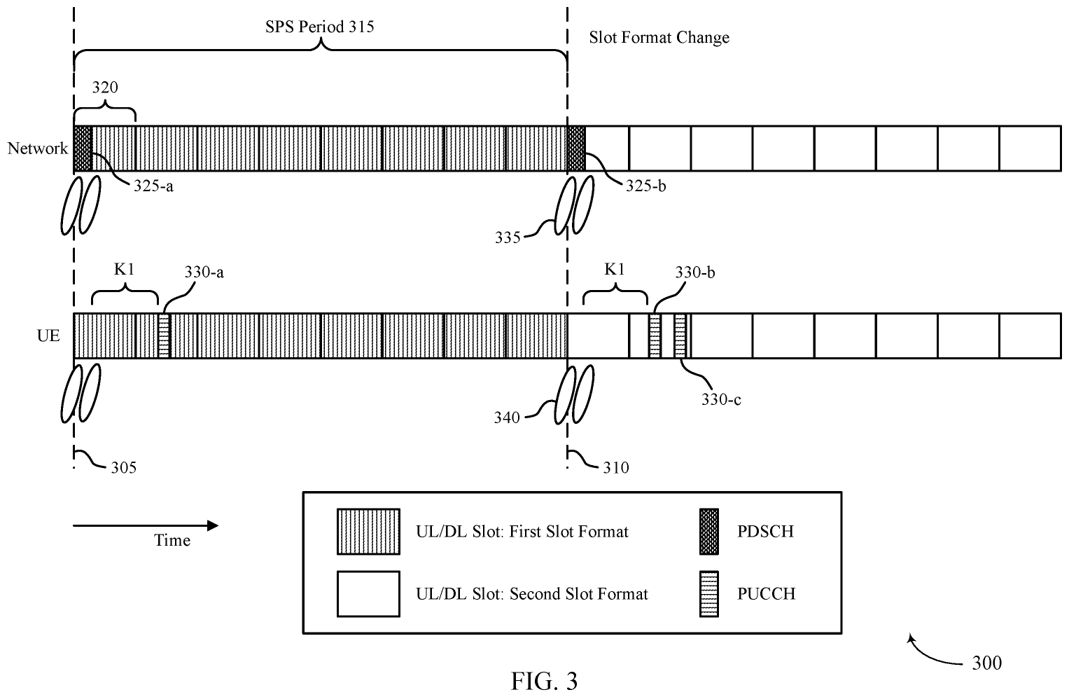

In some aspects, K1 may be a positive integer that refers to a slot offset or a symbol offset between a last symbol of a downlink transmission or a slot carrying the downlink transmission and the starting slot or symbol over which feedback for that downlink transmission is to be transmitted. As such, a K1 value may be defined in terms of a number of symbols or a number of slots, or both. Further, in some aspects, the base station 105-a may transmit the indication of the K1 value to the UE 115-a via downlink control information (DCI) (e.g., such as a scheduling DCI) and the base station 105-a and the UE 115-a may define the K1 value relative to a downlink data transmission scheduled by the DCI. Additional details relating to such a K1 value are illustrated by and described with reference to FIGS. 3 through 5.

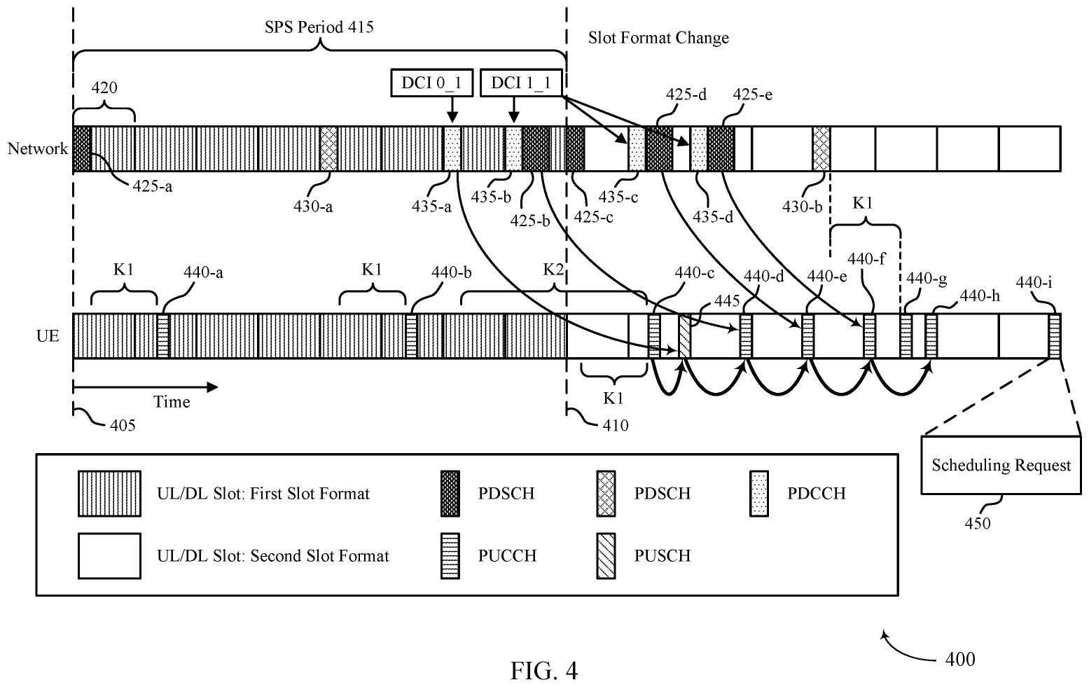

In some cases, however, the resources indicated by the K1 value may become unavailable to the UE 115-a prior to the transmission of the HARQ bits 225 (e.g., one or more HARQ bits 225) over those resources. For example, the resources (e.g., symbol period or slot) indicated by the K1 value may overlap or otherwise conflict with a downlink symbol as a result of a slot format change. In other words, the UE 115-a and the base station 105-a may define the indicated K1 value with respect to or using a first slot format and, if the slot format changes to a second slot format, it is possible that the K1 value may indicate or point to symbols that are configured as downlink symbols in accordance with the second slot format. Additional details relating to such a resource conflict arising from a slot format change are described herein, including with reference to FIGS. 3 and 4. In some aspects, slot formats used by the UE 115-a and the base station 105-a may be examples of TDD slot formats.

Additionally, or alternatively, the resources over which the UE 115-a may transmit the HARQ bits 225 may become unavailable for the HARQ bits 225 as a result of or due to a resource insufficiency. For example, if the resources indicated by the K1 value (which may be physical uplink control channel (PUCCH) resources) are unavailable as a result of a conflict with a configured downlink symbol (e.g., due to a slot format change), the UE 115-a may defer the HARQ bits 225 to next available uplink symbols (which may be physical uplink shared channel (PUSCH) resources). In some cases, however, the UE 115-a may receive another DCI from the base station 105-a requesting a different uplink transmission (e.g., an uplink data transmission) over the next available uplink resources. As such, the UE 115-a may transmit the requested uplink transmission and may be unable to also transmit the HARQ bits 225 over those uplink symbols. Accordingly, the UE 115-a may again defer the HARQ bits 225 to next available uplink symbols. In some cases, however, the UE 115-a may receive additional DCIs and downlink data transmissions and those next available uplink symbols may be configured for feedback responsive to the more recently received downlink data transmissions. Such a resource insufficiency may result in the UE 115-a storing progressively more and more HARQ bits 225 before the UE 115-a is able to find next available uplink symbols that are unused (e.g., free to use for transmitting the stored HARQ bits 225). Additional details relating to such a resource insufficiency are illustrated by and described in more detail herein, including with reference to FIG. 4.

Additionally, or alternatively, the resources over which the UE 115-a may transmit the HARQ bits 225 may become unavailable for the HARQ bits 225 as a result of or due to a cancellation indication. For example, the K1 value may indicate a first uplink resource and, in some cases, the base station 105-a may transmit a cancellation indication to the UE 115-a cancelling the first uplink resource. In some cases, the base station 105-a may perform such a cancelling of the first uplink resource to re-allocate the first uplink resource to a second UE 115. For example, the second UE 115 may have higher priority signaling than the UE 115-a and the base station 105-a may re-allocate the first uplink resource from the UE 115-a to the second UE 115 to provide the second UE 115 with sufficient resources for transmitting the higher priority signaling. As such, however, the UE 115-a may no longer be able to transmit the HARQ bits 225 over the first uplink resource and, in some cases, the UE 115-a may experience difficulty in finding next available uplink resources as a result of a resource insufficiency (e.g., receiving additional downlink transmissions for which feedback is requested and using available uplink resources for more recently received or dynamically scheduled downlink transmissions) or due to receiving additional cancellation indications (e.g., as receiving multiple cancellation indications may be common in some systems, such as in highly congested systems).

Additionally, or alternatively, the resources indicated by the K1 value may become unavailable to the UE 115-a prior to the transmission of the HARQ bits 225 based on a cell switch, a network sleep mode, or any other reason for resource unavailability. In some examples, the UE 115-a may lose connection with the network (e.g., with the base station 105-a). For example, the UE 115-a may lose connection with the base station 105-a after a radio link failure or a beam failure. The UE 115-a may store one or more pending HARQ bits 225, deferred HARQ bits 225 (e.g., bits that encountered interference from downlink transmissions), or HARQ bits 225 scheduled for retransmission. The UE 115-a may reconnect with the network device or a different network device (e.g., a different base station 105 serving a second cell) other than the network device (e.g., the base station 105-a serving a first cell) based on performing radio link failure recovery or beam failure recovery. Additionally, or alternatively, the UE 115-a may reconnect to the network using a different beam. However, in some cases, the resources indicated for the HARQ feedback may occur between when the UE 115-a loses the connection to the network and when the UE 115-a reconnects to the network. As such, the radio link failure, beam failure, or both may cause the resources indicated by the K1 value to become unavailable for HARQ transmission by the UE 115-a, potentially resulting in the UE 115-a storing additional HARQ bits 225 at the UE 115-a for future transmission.

Additionally, or alternatively, if the network device (e.g., the base station 105-a) supports a sleep mode, the network device may enter a sleep mode (e.g., a relatively low power mode) to save power, reduce signaling overhead, or both. During the sleep mode, the network device may refrain from transmitting signaling, receiving signaling, or both. If the resources indicated for the HARQ feedback occur while the network device is operating in the sleep mode, the network device may fail to receive a HARQ transmission by the UE 115-a in the resources. In some examples, the UE 115-a may disconnect from the network based on the network device entering a sleep mode. As such, the UE 115-a may store additional HARQ bits 225 at the UE 115-a for future transmission (e.g., at a time when the network device is operating in a mode that supports HARQ reception). Any of these examples described herein may result in resource conflicts, resource unavailability, or both for the resources indicated for HARQ feedback.

As a result of one or more such resource conflicts, the UE 115-a may accumulate HARQ bits 225 over time and may be unable to find available uplink resources over which to transmit the accumulated HARQ bits 225 for a relatively long duration, which may result in high-latency feedback that may adversely impact scheduling decisions and overall system performance. In some systems, the UE 115-a may transmit a scheduling request 215 to the base station 105-a requesting resources over which the UE 115-a may transmit the accumulated HARQ bits 225. In some examples, the UE 115-a may transmit the scheduling request 215 as a result of the accumulated HARQ bits 225 satisfying a condition (e.g., a triggering condition), and such a condition may be associated with a quantity of the accumulated HARQ bits 225, a content of the accumulated HARQ bits 225, any other characteristic of the accumulated HARQ bits 225, or any combination thereof.

For example, the UE 115-a may transmit the scheduling request 215 if the quantity of the HARQ bits 225 that are stored at the UE 115-a exceeds (or is greater than or equal to) a threshold quantity of HARQ bits. In other words, if the threshold quantity of HARQ bits is N bits, the UE 115-a may transmit the scheduling request 215 if the quantity of the HARQ bits 225 stored at the UE 115-a exceeds N bits. In some examples, the scheduling request 215 may be transmitted based on a quantity of the one or more HARQ bits 225 stored at the UE 115-a being greater than or equal to one (e.g., if N=1). For example, the UE 115-a may trigger transmitting the scheduling request 215 if the UE 115-a stores at least one pending HARQ bit 225. Additionally, or alternatively, the UE 115-a may transmit the scheduling request 215 if the HARQ bits 225 that are stored at the UE 115-a feature, include, or convey a triggering content. For example, the UE 115-a may transmit the scheduling request 215 if any one of the HARQ bits 225 stored at the UE 115-a includes or conveys information relating to a NACK. In other words, if any of the stored HARQ bits 225 is a NACK bit, the UE 115-a may transmit the scheduling request 215. Due to such transmission of the scheduling request 215 based on a presence of a NACK bit in the stored HARQ bits 225, the UE 115-a may expedite feedback that requests or is associated with a potential re-transmission (e.g., in response to a NACK), which may contribute toward more appropriate scheduling decisions, greater reliability, and lower latency.

In some examples, the scheduling request 215 may be a dedicated scheduling request that the UE 115-a exclusively uses for requesting resources over which to transmit the accumulated or pending HARQ bits 225. For example, the scheduling request 215 may be a distinct type of scheduling request and, accordingly, may be different from any scheduling requests that the UE 115-a may transmit based on an uplink buffer linked with uplink RLC entities (e.g., logical channels, even if such logical channels carry RRC control or “L3 Control”). Further, the scheduling request 215 may similarly be different from a scheduling request that the UE 115-a may transmit as part of a beam failure recovery (BFR) procedure, which may be referred to herein as a BFR scheduling request.

The UE 115-a may transmit the scheduling request 215 via UCI along with other UCI content, which may include HARQ bits (e.g., feedback responsive to a more recently received or dynamically scheduled downlink transmission), one or more other scheduling requests, or one or more channel state information (CSI) reports, or any combination thereof. In some examples, the UE 115-a may multiplex the scheduling request 215 with any other UCI content that is included in the UCI in accordance with one or more multiplexing rules. In some examples, such multiplexing rules may specify a rule for how the UE 115-a may construct the UCI based on relative priorities of different UCI content. As such, the UE 115-a may include the scheduling request 215 within the UCI in accordance with a priority of scheduling requests associated with HARQ feedback (e.g., scheduling requests requesting resources over which HARQ feedback may be transmitted may be associated with a unique priority) and based on comparing that priority with priorities of other potential UCI content. In some aspects, scheduling requests associated with HARQ feedback may have a lowest priority relative to other UCI content, apart from (e.g., with the exception of) CSI reports.

The UE 115-a may convey the scheduling request 215 via one or more bits in a dedicated location in the UCI content (e.g., a location that is dedicated for scheduling requests associated with HARQ feedback) or via a field in the UCI content (e.g., in a field that is dedicated for scheduling requests associated with HARQ feedback). As such, the UE 115-a or the base station 105-a may identify the scheduling request 215 based on its location in the UCI content or based on the field in the UCI content, or both.

In some examples, the UE 115-a may receive signaling indicating a configuration of resources for the scheduling request 215 (or for scheduling requests associated with HARQ feedback generally). For example, such signaling may configure resources to be exclusively for scheduling requests associated with HARQ feedback that is stored or pending at the UE 115-a. In some aspects, the UE 115-a may receive such signaling from the base station 105-a and, in some examples, the configuration may include a SchedulingRequestResourceConfig information element. As such, the UE 115-a may transmit the scheduling request 215 over the configured resources. The resources over which the UE 115-a transmits the scheduling request 215 may include PUCCH resources, PUSCH resources (e.g., such as configured grant PUSCH resources), or a combination thereof.

In examples in which the UE 115-a transmits the scheduling request 215 over PUCCH resources, the UE 115-a may multiplex the scheduling request with other UCI content in accordance with or based on a PUCCH format associated with the PUCCH resources. For example, if the UE 115-a transmits the scheduling request 215 using a PUCCH format 0 or a PUCCH format 2 and if no other type of scheduling request is present in the UCI content, the UE 115-a may multiplex the scheduling request 215 with UCI content based on applying an identifier-specific phase shift. For example, the UE 115-a may multiplex the scheduling request 215 with the other UCI content using a phase shift that is specific, unique, or special to the UE 115-a. In some aspects, PUCCH formats 0 and 2 may be associated with one or two HARQ bits and the UE 115-a may multiplex the scheduling request 215 with such one or two HARQ bits using the identifier-specific phase shift. Such a phase shift may include a shift of 0 degrees, 90 degrees, 180 degrees, 270 degrees, or any combination thereof as well as any offset (e.g., such as a 45 degree offset) relative to any combination thereof. For example, a first PUCCH format 0 may be associated with a cyclic shift of 0 degrees and 180 degrees while a second PUCCH format 0 may be associated with a cyclic shift of 90 degrees and 270 degrees, and a shift of 45 degrees (or any other number of degrees) may be applied to convey some additional information.

In some examples, the UE 115-a may detect that the accumulated or stored HARQ bits 225 satisfy the triggering condition while no uplink channel between the UE 115-a and the base station 105-a is available. For example, the UE 115-a may enter a sleep mode and may lose a connection with the base station 105-a. In such examples, the UE 115-a may transmit a random access message, such as a message 1 (msg1) or message A (msgA) to the base station 105-a to initiate a random access procedure. The UE 115-a and the base station 105-a may perform the random access procedure as a result of the UE 115-a transmitting the random access message and, upon establishment of a connection or an uplink channel between the UE 115-a and the base station 105-a, the UE 115-a may transmit the scheduling request 215.

The base station 105-a, as a result of receiving the scheduling request 215 from the UE 115-a, may allocate uplink resources for the transmission of the HARQ bits 225 and may transmit control signaling 220 to the UE 115-a indicating the uplink resource allocation (e.g., a time and frequency resource allocation) for the HARQ bits 225. The control signaling may indicate a type of the uplink channel over which the UE 115-a is to transmit the HARQ bits 225, and the uplink resource allocation may include PUCCH resources or PUSCH resources depending on the type of channel indicated by the control signaling 220. In examples in which the uplink resource allocation includes PUCCH resources, the base station 105-a may further indicate, via the control signaling 220, a PUCCH format that the UE 115-a may apply for the transmission carrying the HARQ bits 225. Alternatively, in examples in which the uplink resource allocation includes PUSCH resources, the UE 115-a may multiplex the HARQ bits 225 with the PUSCH. In other words, the UE 115-a may multiplex the HARQ bits 225 with a data transmission that is also sent over the PUSCH.

Additionally, or alternatively, the control signaling 220 may include an indication of one or more HARQ process identifiers for which feedback is requested. For example, the UE 115-a may store or accumulate HARQ bits 225 corresponding to various (e.g., any) HARQ process identifiers (e.g., in any component carrier) and may transmit the scheduling request 215 as a result of a total number of the HARQ bits 225 across all HARQ process identifiers satisfying the triggering condition or as a result of HARQ bits 225 of a subset of one or more HARQ process identifiers satisfying the triggering condition. In either example, the base station 105-a may request, via the control signaling 220, HARQ bits 225 associated with HARQ process identifiers that are indicated via the control signaling 220.

In some aspects, the base station 105-a may transmit the control signaling 220 via various signaling types, including DCI. In examples in which the base station 105-a transmits the control signaling 220 via DCI, the base station 105-a may apply various DCI formats. For example, the base station 105-a may transmit the control signaling 220 using a DCI format 1_1, a DCI format 1_0, a DCI format 0_0, a DCI format 0_1, or any combination thereof. Based on conveying the uplink resource allocation via such various DCI formats, the base station 105-a may avoid delays in indicating the uplink resource allocation even if there are more downlink packets to be sent to the UE 115-a. For example, if a downlink packet is scheduled for the UE 115-a via a DCI format 1_1 or a DCI format 1_0, the base station 105-a may include the indication of the uplink resource allocation within the DCI format 1_1 or the DCI format 1_0 and refrain from transmitting a separate DCI format 0_0 or DCI format 0_1 to indicate the uplink resource allocation.

The UE 115-a may receive the control signaling 220, identify the uplink resource allocation indicated by the control signaling 220, and transmit the stored or accumulated HARQ bits 225 to the base station 105-a over the indicated uplink resource allocation. As such, the UE 115-a may provide the base station 105-a with feedback in a more reliable manner and with lower latency than may otherwise have been achievable, which may provide the base station 105-a with more information to use for making scheduling decisions and increase the likelihood for successful communications between the UE 115-a and the base station 105-a. Further, as a result of implementing the described signaling mechanism and scheduling request 215, the base station 105-a may transmit any number of cancellation indications or configure slot format changes without risking loss of feedback, which may increase overall system performance and throughput, especially in highly congested systems.

FIG. 3 illustrates an example of a communication timeline 300 that supports techniques for transmitting a scheduling request for pending HARQ bits in accordance with aspects of the present disclosure. The communication timeline 300 may implement or be implemented to realize aspects of the wireless communications system 100 or the wireless communications system 200. For example, the communication timeline 300 may illustrate communication between a UE 115 and a network device (e.g., a base station 105 or another network entity), which may be examples of corresponding devices described herein, including with reference to FIGS. 1 and 2. In some examples, the UE 115 may experience a resource conflict at resources over which the UE 115 is scheduled to transmit feedback as a result of a slot format change and may defer a transmission of the feedback to next available uplink symbols.

For example, the UE 115 and the base station 105 may communicate in accordance with a first slot format at 305 and may switch to a second slot format at 310. Between 305 and 310, the UE 115 and the base station 105 may communicate during a semi-persistent scheduling (SPS) period 315 including a number of slots 320. In some examples, the SPS period 315 may span 1 millisecond or 112 symbols. Further, each slot 320 may span 125 microseconds or 14 symbols. In some aspects, and in accordance with the SPS period 315, a physical downlink shared channel (PDSCH) 325-a and a PDSCH 325-b may be examples of semi-persistently scheduled PDSCH transmissions.

In some examples, the base station 105 may transmit the PDSCH 325-a (e.g., signaling on a PDSCH) to the UE 115 using one or more transmit beams 335 and, accordingly, the UE 115 may receive the PDSCH 325-a using one or more receive beams 340 and may attempt to decode the PDSCH 325-a. In some aspects, DCI scheduling the PDSCH 325-a may indicate a K1 value that the UE 115 may use to identify resources (e.g., symbol(s) or a slot) over which the UE 115 may transmit feedback (e.g., HARQ bits) to the base station 105 responsive to the PDSCH 325-a. Alternatively, K1 may be pre-configured at the UE 115 as a result of a semi-persistent nature of the PDSCH 325. In some aspects, K1 may be equal to 20 symbols (e.g., in FR2). For example, the UE 115 may transmit ACK or NACK feedback over a PUCCH 330-a depending on whether the UE 115 successfully decoded the PDSCH 325-a (e.g., the signaling on the PDSCH). In some aspects, the PDSCH 325-a and the PUCCH 330-a may be separated or offset by K1 or by a number of symbols based on K1.

In some examples, the base station 105 may configure a slot format change at 310. For example, the base station 105 may configure the slot format change via an RRC information element SlotFormatCombinationsPerCell and, according to the configuration (e.g., according to the pattern defined in SlotFormatCombinationsPerCell), the slot format may switch from the first slot format to the second slot format at 310. In some aspects, the first slot format may be a slot format 42 including three downlink symbols, three flexible symbols, and eight uplink symbols and the second slot format may be a slot format 33 including nine downlink symbols, three flexible symbols, and two uplink symbols. As such, the switch from the first slot format to the second slot format may feature a decrease in the quantity of uplink symbols in each slot and an increase in the quantity of downlink symbols in each slot, which may result in fewer resources being available for uplink transmissions (e.g., such as HARQ feedback transmissions).

For example, the base station 105 may transmit the PDSCH 325-b (e.g., signaling on a PDSCH) using one or more transmit beams 335 and the UE 115 may accordingly receive the PDSCH 325-b using one or more receive beams 340 and may attempt to decode the PDSCH 325-b. The PDSCH 325-b may be associated with a K1 value scheduling the UE 115 for a feedback transmission associated with the PDSCH 325-b, however, in some cases, the K1 value may be set assuming the first slot format (and not the second slot format). For example, the base station 105 may construct the scheduling DCI based on the first slot format or transmit the scheduling DCI during the SPS period 315 associated with the first slot format, or the PDSCHs 325 may be semi-persistently scheduled, such that the K1 value (which may be associated with 20 symbols) is defined in accordance with the first slot format.

As such, the scheduled HARQ feedback transmission over PUCCH 330-b (e.g., PUCCH resources) may collide or otherwise conflict with a downlink symbol. In such examples, the UE 115 may refrain from transmitting the HARQ feedback for the PDSCH 325-b over the PUCCH 330-b (as the symbol associated with the PUCCH 330-b resource collides with a downlink symbol according to the second slot format) and may store or defer the HARQ feedback for a next available uplink symbol. For example, the semi-persistently scheduled PUCCH A/N resource may be a PUCCH format 0 (1 bit), hence a first or earliest uplink PUCCH 330 resource corresponds to a first or earliest available uplink symbol. In some aspects, the first available uplink symbol may be found according to K1+7 symbols. In some examples, and as shown in FIG. 3, the UE 115 may refrain from transmitting a scheduling request that requests resources for deferred HARQ bits as a result of the deferred HARQ bits failing to satisfy the triggering condition. For example, the UE 115 may transmit the deferred HARQ bits over a PUCCH 330-c (e.g., a set of PUCCH resources) if the PUCCH 330-c is available. In some cases, however, the next available uplink symbols (e.g., such as the symbols associated with the PUCCH 330-c) may be occupied by other signaling, as illustrated by and described with reference to FIG. 4.

FIG. 4 illustrates an example of a communication timeline 400 that supports techniques for transmitting a scheduling request for pending HARQ bits in accordance with aspects of the present disclosure. The communication timeline 400 may implement or be implemented to realize aspects of the wireless communications system 100 or the wireless communications system 200. For example, the communication timeline 400 may illustrate communication between a UE 115 and a network device (e.g., a base station 105 or another network entity), which may be examples of corresponding devices described herein, including with reference to FIGS. 1 and 2. In some examples, the UE 115 may defer HARQ feedback to a next available uplink symbol as a result of a resource conflict (e.g., such as a resource conflict resulting from a slot format change). In some cases, however, such next available uplink symbols may be occupied by other signaling, resulting in an accumulation of HARQ bits in available uplink symbols and the transmission of a scheduling request 450 if the accumulated HARQ bits satisfy a triggering condition.

For example, the UE 115 and the base station 105 may communicate in accordance with a first slot format at 405 and may switch to a second slot format at 410. Between 405 and 410, the UE 115 and the base station 105 may communicate during an SPS period 415 including a number of slots 420. In some examples, the SPS period 415 may span 1 millisecond or 112 symbols. Further, each slot 420 may span 125 microseconds or 14 symbols. In some examples, and in accordance with the SPS period 415, the PDSCH 425-a and the PDSCH 425-c may be examples of first semi-persistently scheduled PDSCHs and the PDSCH 430-a and the PDSCH 430-b may be examples of second semi-persistently scheduled PDSCHs (each having an SPS period of 1 millisecond).

In some examples, the base station 105 may transmit the PDSCH 425-a (e.g., signaling on a PDSCH) to the UE 115 and, accordingly, the UE 115 may receive the PDSCH 425-a and may attempt to decode the PDSCH 425-a. In some aspects, DCI scheduling the PDSCH 425-a may indicate a K1 value that the UE 115 may use to identify resources (e.g., symbol(s) or a slot) over which the UE 115 may transmit feedback (e.g., HARQ bits) to the base station 105 responsive to the PDSCH 425-a. Alternatively, K1 may be pre-configured at the UE 115 in accordance with the semi-persistent nature of the PDSCH 425-a. In some aspects, K1 may be equal to 20 symbols (e.g., in FR2). The UE 115 may transmit ACK or NACK feedback over a PUCCH 440-a depending on whether the UE 115 successfully decoded the PDSCH 425-a (e.g., the PDSCH signaling). In some aspects, the PDSCH 425-a and the PUCCH 440-a may be separated or offset by K1 or by a number of symbols based on K1.

During the SPS period 415, the base station 105 may also transmit the PDSCH 430-a (e.g., additional signaling on a PDSCH) to the UE 115 and, accordingly, the UE 115 may receive the PDSCH 430-a and attempt to decode the PDSCH 430-a. In some examples, the UE 115 may transmit feedback to the base station 105 responsive to the PDSCH 430-a over a PUCCH 440-b that is defined or indicated by a K1 value, which may be associated with 20 symbols (e.g., in FR2).

The base station 105 may also transmit a DCI format 0_1 over a physical downlink control channel (PDCCH) 435-a scheduling an uplink transmission, from the UE 115 to the base station 105, and the DCI format 0_1 may include an indication of a K2 value indicating when the UE 115 is scheduled to make the uplink transmission. For example, the K2 value may be defined relative to the DCI format 0_1 and may point to or otherwise indicate a PUSCH 445 over which the UE 115 is scheduled to perform the uplink transmission to the base station 105.

In some examples, the base station 105 may also transmit one or more DCI formats 1_1 via PDCCH 435-b, PDCCH 435-c, and PDCCH 435-d that schedule a PDSCH 425-b, a PDSCH 425-d, and a PDSCH 425-e, respectively. The UE 115 may attempt to decode each of such dynamically scheduled PDSCHs and may be configured to report feedback for each of the dynamically scheduled PDSCHs (e.g., PDSCH messages) over indicated or earliest available PUCCH 440 resources. For example, the UE 115 may expect to transmit feedback responsive to the PDSCH 425-b over a PUCCH 440-d, feedback responsive to the PDSCH 425-d over a PUCCH 440-e, and feedback responsive to the PDSCH 425-e over a PUCCH 440-f.

In some examples, the base station 105 may configure a slot format change at 410. For example, the base station 105 may configure the slot format change via an RRC information element SlotFormatCombinationsPerCell and, according to the configuration (e.g., according to the pattern defined in SlotFormatCombinationsPerCell), the slot format may switch from the first slot format to the second slot format at 410. In some aspects, the first slot format may be a slot format 42 including three downlink symbols, three flexible symbols, and eight uplink symbols and the second slot format may be a slot format 33 including nine downlink symbols, three flexible symbols, and two uplink symbols. As such, the switch from the first slot format to the second slot format may feature a decrease in the quantity of uplink symbols in each slot and an increase in the quantity of downlink symbols in each slot, which may result in fewer resources being available for uplink transmissions (e.g., such as HARQ feedback transmissions).

For example, the base station 105 may transmit a PDSCH 425-c (e.g., a message over a PDSCH) and, accordingly, the UE 115 may receive the PDSCH 425-c and attempt to decode the PDSCH 425-c. The PDSCH 425-c may be associated with a K1 value scheduling the UE 115 for a feedback transmission associated with the PDSCH 425-c. In some cases, however, the K1 value may be set assuming the first slot format (and not the second slot format). For example, the base station 105 may construct the scheduling DCI based on the first slot format or transmit the scheduling DCI during the SPS period 415 associated with the first slot format, or the PDSCH 425-c may be semi-persistently scheduled, such that the K1 value (which may be associated with 20 symbols) is defined in accordance with the first slot format.

As such, the scheduled HARQ feedback transmission over PUCCH 440-c may collide or otherwise conflict with a downlink symbol. In such examples, the UE 115 may refrain from transmitting the HARQ feedback for the PDSCH 425-c over the PUCCH 440-c (as the symbol associated with the PUCCH 440-c resource collides with a downlink symbol according to the second slot format) and may store or defer the HARQ feedback for a next available uplink symbol. In some cases, the SPS PUCCH A/N (e.g., the PUCCH 440 over which the UE 115 transmits feedback for semi-persistently scheduled PDSCHs) may be a PUCCH format 3 (12 bits) for the PDSCH 425-a and the PDSCH 425-c as well as for the PDSCH 430-a and the PDSCH 430-b.

In examples in which the UE 115 receives the DCI format 0_1 over the PDCCH 435-a, however, the next available uplink symbols (e.g., the uplink symbols of the PUSCH 445) may be occupied by the uplink transmission scheduled by the DCI format 0_1 and the UE 115 may be unable to multiplex the deferred HARQ bits with the uplink transmission over the PUSCH 445. As such, the UE 115 may be unable to transmit the deferred HARQ bits over the PUSCH 445 and may seek a next available uplink symbol (e.g., after the PUSCH 445). For example, the UE 115 may attempt to transmit the deferred HARQ bits during sets of symbols associated with the PUCCH 440-d, the PUCCH 440-e, or the PUCCH 440-f. In examples in which the UE 115 receives the dynamic grants for the PDSCH 425-b, the PDSCH 425-d, and the PDSCH 425-e, however, the UE 115 may elect or be configured to transmit feedback responsive to each of those dynamic grant PDSCHs over the PUCCH 440-d, the PUCCH 440-e, and the PUCCH 440-f, respectively, and the UE 115 may be unable to multiplex the deferred HARQ bits with the feedback responsive to the dynamic grant PDSCHs. As such, the deferred HARQ bits may remain pending transmission (e.g., the UE 115 may continue to store the deferred HARQ bits).

Further, the base station 105 may transmit the PDSCH 430-b and, accordingly, the UE 115 may receive the PDSCH 430-b and attempt to decode the PDSCH 430-b. With similarity to the other semi-persistently scheduled PDSCHs, the PDSCH 430-b may be associated with a K1 value scheduling the UE 115 for a feedback transmission associated with the PDSCH 430-b. In some cases, however, the K1 value may be set assuming the first slot format (and not the second slot format) and, in some examples, the K1 value may indicate a resource that conflicts with a downlink symbol. For example, the K1 value may indicate a PUCCH 440-g, however the symbol(s) associated with the PUCCH 440-g may conflict with a downlink symbol (e.g., in accordance with the second slot format). As such, the UE 115 may defer HARQ bits associated with the PDSCH 430-b such that the UE 115 stores HARQ bits for both the PDSCH 425-c and the PDSCH 430-b. In other words, due to a combination of a slot format change and a resource insufficiency (or due to the transmission of dynamic grants), the UE 115 may potentially accumulate HARQ bits over time as next available uplink symbols become occupied with other signaling. In some aspects, the UE 115 may again try to transmit the accumulated HARQ bits over a PUCCH 440-h. In some cases, however, the UE 115 may be unable to completely transmit the accumulated HARQ bits over the PUCCH 440-h (e.g., due to a resource conflict).

Accordingly, in some examples of the present disclosure, the UE 115 may transmit a scheduling request 450 requesting resources over which the UE 115 may transmit deferred HARQ bits if the deferred HARQ bits that are stored at the UE 115 satisfy a triggering condition. For example, and as illustrated in FIG. 4, the UE 115 may transmit the scheduling request 450 requesting resources for deferred HARQ bits over a PUCCH 440-i as a result of the deferred HARQ bits satisfying the triggering condition. Further, although shown as being transmitted over a PUCCH 440, the UE 115 may similarly transmit the scheduling request 450 over a PUSCH without exceeding the scope of the present disclosure. Additional details relating to such a scheduling request 450 associated with HARQ bits are described herein, including with reference to FIG. 2.

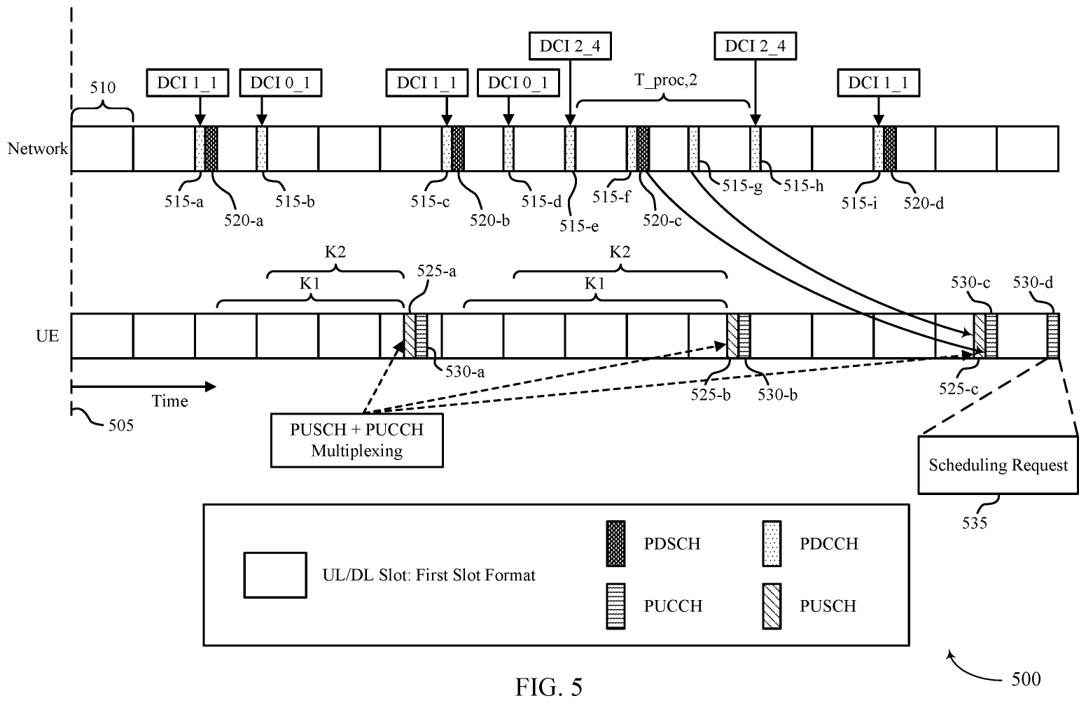

Additionally, or alternatively, the UE 115 may similarly accumulate HARQ bits as a result of receiving one or more cancellation indications from the base station 105, as illustrated by and described in more detail with reference to FIG. 5.

FIG. 5 illustrates an example of a communication timeline 500 that supports techniques for transmitting a scheduling request for pending HARQ bits in accordance with aspects of the present disclosure. The communication timeline 500 may implement or be implemented to realize aspects of the wireless communications system 100 or the wireless communications system 200. For example, the communication timeline 500 may illustrate communication between a UE 115 and a network device (e.g., a base station 105 or another network entity), which may be examples of corresponding devices described herein, including with reference to FIGS. 1 and 2. In some examples, the UE 115 may accumulate a number of HARQ bits, such as one or more HARQ bits stored at the UE 115, as a result of receiving one or more cancellation indications from the base station 105 and may transmit a scheduling request 535 as a result of the accumulated HARQ bits satisfying a triggering condition.

For example, the UE 115 and the base station 105 may communicate in accordance with the communication timeline 500 beginning at 505 and may communicate over a number of slots 510. In some aspects, each slot 510 may span 125 microseconds or 14 symbols. Further, in some aspects, the UE 115 and the base station 105 may communicate in accordance with a first slot format. In some examples, the first slot format may be a slot format 45 including six downlink symbols, two flexible symbols, and six uplink symbols.

In some examples, the base station 105 may transmit a DCI format 1_1 over a PDCCH 515-a scheduling a PDSCH 520-a (e.g., scheduling resources for PDSCH transmission) and, accordingly, the UE 115 may attempt to decode the PDSCH 520-a. The DCI format 1_1 sent over the PDCCH 515-a may indicate a K1 value (which may be associated with 48 symbols or 24 two-symbol sub-slots) and the UE 115 may use the indicated K1 value to identify resources (e.g., symbols) over which to transmit HARQ feedback associated with the PDSCH 520-a. In some examples, the base station 105 may also transmit a DCI format 0_1 over a PDCCH 515-b scheduling an uplink transmission from the UE 115 to the base station 105. The DCI format 0_1 may include a K2 value (which may be associated with 36 symbols) and the UE 115 may use the indicated K2 value to identify resources (e.g., symbols) over which to transmit the scheduled uplink transmission.

In some examples, the DCI format 1_1 and the DCI format 0_1 may indicate a same or at least a partially overlapping set of symbols, such as symbols associated with a PUSCH 525-a and a PUCCH 530-a. In such examples, the UE 115 may transmit the feedback requested by the DCI format 1_1 over the PUCCH 530-a and may transmit the uplink transmission scheduled by the DCI format 0_1 over the PUSCH 525-a. In some examples, the UE 115 may multiplex the PUSCH 525-a and the PUCCH 530-a to transmit both the uplink transmission and the requested feedback together.

The base station 105 may similarly transmit another DCI format 1_1 (e.g., a second DCI format 1_1) over a PDCCH 515-c scheduling a PDSCH 520-b as well as another DCI format 0_1 (e.g., a second DCI format 0_1) over a PDCCH 515-d scheduling another uplink transmission from the UE 115 to the base station 105. The DCI format 1_1 sent over the PDCCH 515-c may indicate a K1 value (which may be associated with 48 symbols or 24 two-symbol sub-slots) defining or indicating resources (e.g., symbols) over which the UE 115 may transmit feedback associated with the PDSCH 520-b and the DCI format 0_1 sent over the PDCCH 515-d may indicate a K2 value (which may be associated with 36 symbols) defining or indicating resources (e.g., symbols) over which the UE 115 may transmit the scheduled uplink transmission to the base station 105. In some aspects, the DCI format 1_1 and the DCI format 0_1 may indicate a same or at least a partially overlapping set of symbols, such as symbols associated with a PUSCH 525-b and a PUCCH 530-b.

In some cases, however, the base station 105 may transmit a DCI format 2_4 over a PDCCH 515-e including a cancellation indication associated with the PUSCH 525-b or the PUCCH 530-b, or both, prior to the UE 115 transmitting the requested feedback and scheduled uplink transmission over the PUCCH 530-b and the PUSCH 525-b, respectively. As such, the UE 115 may refrain from transmitting the requested HARQ bits or the scheduled uplink transmission, or both, and may store the HARQ bits for later uplink signaling.

In some examples, the base station 105 may similarly transmit another DCI format 1_1 (e.g., a third DCI format 1_1) over a PDCCH 515-f scheduling a PDSCH 520-c as well as another DCI format 0_1 (e.g., a third DCI format 0_1) over a PDCCH 515-g scheduling another uplink transmission from the UE 115 to the base station 105. The DCI format 1_1 sent over the PDCCH 515-f may indicate a K1 value (which may be associated with 48 symbols or 24 two-symbol sub-slots) defining or indicating resources (e.g., symbols) over which the UE 115 may transmit feedback associated with the PDSCH 520-c and the DCI format 0_1 sent over the PDCCH 515-g may indicate a K2 value (which may be associated with 36 symbols) defining or indicating resources (e.g., symbols) over which the UE 115 may transmit the scheduled uplink transmission to the base station 105. In some examples, the K1 and K2 values may indicate a PUCCH 530-c and a PUSCH 525-c, respectively. As such, the UE 115 may plan or expect to transmit feedback associated with the PDSCH 520-c and the scheduled uplink transmission over the PUCCH 530-c and the PUSCH 525-c, respectively.

In some cases, however, the base station 105 may transmit a DCI format 2_4 (e.g., a second DCI format 2_4) over a PDCCH 515-h including a cancellation indication associated with the PUSCH 525-c or the PUCCH 530-c, or both, prior to the UE 115 transmitting the requested feedback and scheduled uplink transmission over the PUCCH 530-c and the PUSCH 525-c, respectively. In some aspects, the base station 105 may transmit the DCI format 2_4 over the PDCCH 515-h a threshold time duration after transmitting the DCI format 2_4 over the PDCCH 515-e. Such a threshold time duration may be referred to as T_proc,2 and may be associated with 38 symbols. The UE 115 may refrain from transmitting the requested HARQ bits or the scheduled uplink transmission, or both, and may store the HARQ bits for later uplink signaling. As such, the UE 115 may accumulate HARQ bits associated with the PDSCH 520-b and the PDSCH 520-c. Further, a similar accumulation of HARQ bits may occur when HARQ bits or PUCCH are multiplexed with PUSCH (e.g., such as configured grant PUSCH).

In some examples, the base station 105 may transmit the DCI formats 2_4 including cancellation indications to re-allocate resources from the UE 115 to a second, different UE 115. For example, such a second UE 115 may have higher priority signaling than the UE 115 and the base station 105 may re-allocate resources from the UE 115 to the second UE 115 to provide the second UE 115 with sufficient resources for the higher priority signaling. Further, such a transmission of multiple DCI formats 2_4 may be common in some systems, such as in highly congested systems, as the base station 105 attempts to provide sufficient resources for multiple UEs 115.

In some examples, the base station 105 may also transmit another DCI format 1_1 over a PDCCH 515-i scheduling a PDSCH 520-d, and such an additional DCI format 1_1 may similarly indicate a K1 that the UE 115 may use to select resources over which to transmit feedback associated with the PDSCH 520-d. Accordingly, the number of HARQ bits that are stored at the UE 115 may accumulate as more cancellation indications are received and, in some cases, the UE 115 may transmit a scheduling request 535 if the number of HARQ bits stored at the UE 115 satisfy a triggering condition. For example, and as illustrated in FIG. 5, the UE 115 may transmit the scheduling request 535 requesting resources for the accumulated HARQ bits over a PUCCH 530-d as a result of the accumulated HARQ bits satisfying the triggering condition. Further, although shown as being transmitted over a PUCCH 530, the UE 115 may additionally, or alternatively, transmit the scheduling request 535 over a PUSCH (e.g., a PUSCH 525) without exceeding the scope of the present disclosure.

In some examples, the UE 115 may transmit the scheduling request 535 together with HARQ feedback for a dynamic grant PDSCH, such as the PDSCH 520-d, as there may not be sufficient resources for multiplexing canceled (e.g., accumulated or deferred) HARQ bits with new HARQ bits (e.g., HARQ bits associated with feedback for the PDSCH 520-d). Additional details relating to such a scheduling request 535 associated with HARQ bits are described herein, including with reference to FIG. 2.

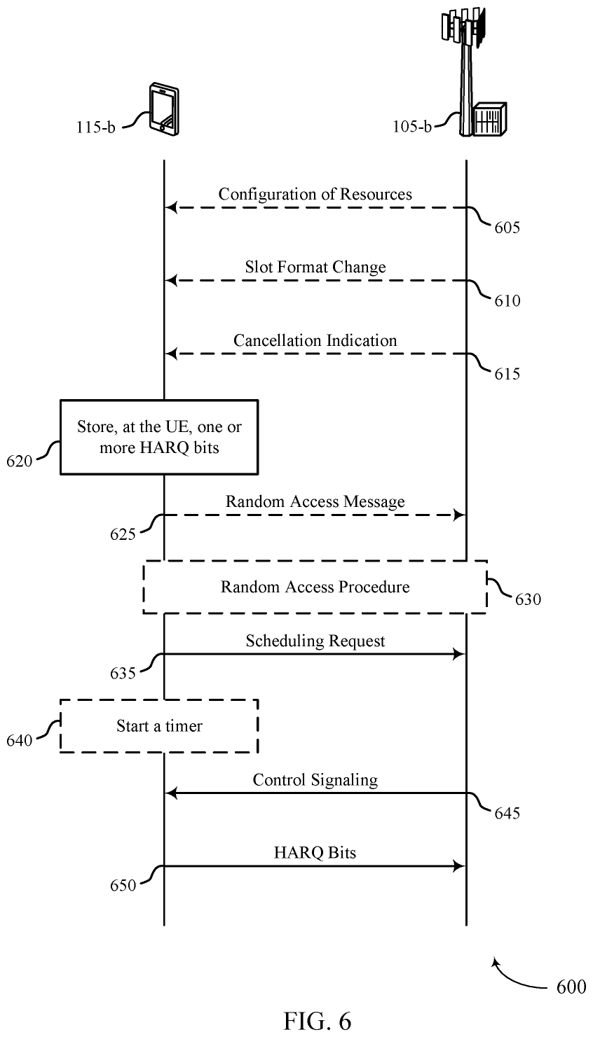

FIG. 6 illustrates an example of a process flow 600 that supports techniques for transmitting a scheduling request for pending HARQ bits in accordance with aspects of the present disclosure. The process flow 600 may implement or be implemented to realize aspects of the wireless communications system 100 or the wireless communications system 200. For example, the process flow 600 may illustrate communication between a UE 115-b and a network device (e.g., a base station 105-b or another network entity), which may be examples of corresponding devices described herein, including with reference to FIGS. 1 and 2. In some examples, the UE 115-b may transmit a scheduling request associated with (e.g., dedicated for) HARQ feedback bits as a result of a number of HARQ bits that are stored at the UE 115-b satisfying a triggering condition.

In the following description of the process flow 600, the operations may be performed (e.g., reported or provided) in a different order than the order shown, or the operations performed by the example devices may be performed in different orders or at different times. For example, specific operations may also be left out of the process flow 600, or other operations may be added to the process flow 600. Further, although some operations or signaling may be shown to occur at different times for discussion purposes, these operations may actually occur at the same time.

At 605, the UE 115-b may receive (e.g., from the base station 105-b) signaling indicating a configuration of resources for the scheduling request. In some examples, the configured resources may be exclusively for scheduling requests associated with HARQ bits that are stored at the UE 115-b (e.g., deferred or accumulated HARQ bits).

At 610, the UE 115-b may, in some examples, receive an indication of a slot format change (e.g., from the base station 105-b). In some examples, the indication of the slot format change may include or indicate a pattern of slot formats and the UE 115-b and the base station 105-b may switch between different slot formats in accordance with the pattern. In some cases, such a switching between slot formats may result in resource conflicts for feedback transmissions associated with semi-persistently scheduled downlink transmissions, as described in more detail herein, including with reference to FIG. 4.

At 615, the UE 115-b may, in some examples, receive a cancellation indication (e.g., from the base station 105-b). In some examples, the cancellation indication may cancel resources over which the UE 115-b was scheduled to transmit feedback and, if multiple cancellation indications are received by the UE 115-b, the UE 115-b may progressively accumulate more pending HARQ bits, as described in more detail herein, including with reference to FIG. 5.

At 620, for example, the UE 115-b may store, at the UE 115-b, a number of HARQ bits (e.g., one or more HARQ bits) associated with one or more HARQ process identifiers of the UE 115-b. In some examples, the UE 115-b may store the HARQ bits as a result of one or more resource conflicts, such as resource conflicts that may result from a slot format change, an insufficiency of resources, or a cancellation indication.

At 625, the UE 115-b may, in some examples, transmit a random access message associated with a random access procedure based on the one or more HARQ bits stored at the UE 115-b satisfying a triggering condition and based on the UE 115-b being in an unconnected state or otherwise not having an uplink channel to the network (e.g., the base station 105-b).

At 630, in such examples in which the UE 115-b transmits the random access message, the UE 115-b and the network (e.g., via the base station 105-b) may perform the random access procedure and may establish a connection as a result of the random access procedure. As such, in examples in which the UE 115-b initially lacked an uplink channel to the network, the UE 115-b and the network (e.g., the base station 105-b) may establish such an uplink channel as a result of the random access procedure.

At 635, the UE 115-b may transmit a scheduling request associated with the one or more HARQ bits based a quantity of the one or more HARQ bits stored at the UE 115-b. For example, the UE 115-b may transmit the scheduling request as a result of the number of HARQ bits stored at the UE 115-b satisfying a triggering condition (and, in some examples, as a result of establishing the connection with the base station 105-b). In some examples, the UE 115-b may include the scheduling request in UCI in accordance with a priority of scheduling requests associated with HARQ bits that are stored at the UE 115-b. The UE 115-b may transmit the scheduling request via one or more bits in the UCI, which may be associated with a location in UCI content or a field in UCI content that are dedicated for scheduling requests associated with HARQ bits that are stored at the UE 115-b. The UE 115-b may transmit the scheduling request over a PUSCH resource or a PUCCH resource and, in some examples, in accordance with the configuration received at 605. In some examples, the UE 115-b may transmit the scheduling request based on multiplexing the scheduling request with other HARQ bits using an identifier-specific (e.g., a UE identifier-specific) phase shift to the signaling conveying the scheduling request.

At 640, the UE 115-b may, in some examples, start a timer as a result of transmitting the scheduling request associated with the one or more HARQ bits. In some such examples, the UE 115-b may refrain from transmitting another scheduling request associated with HARQ bits for a duration of the timer.

At 645, the UE 115-b may receive (e.g., from the base station 105-b) control signaling indicating an uplink resource allocation for a transmission of the HARQ bits. In some examples, the control signaling may include DCI and may indicate a type of channel associated with the uplink resource allocation. For example, the control signaling may indicate that the uplink resource allocation includes a PUCCH resource or a PUSCH resource. In examples in which the uplink resource allocation includes a PUCCH resource, the control signaling may additionally indicate a PUCCH format that the UE 115-b may apply for the transmission of the HARQ bits. In some examples, the control signaling may indicate one or more HARQ process identifiers for which feedback is requested (where such one or more HARQ process identifiers may be all HARQ process identifiers of the UE 115-b or may be a subset of the HARQ process identifiers of the UE 115-b).

At 650, the UE 115-b may transmit the one or more HARQ bits over the uplink resource allocation. In examples in which the UE 115-b transmits the HARQ bits over a PUCCH, the UE 115-b may transmit the HARQ bits over the PUCCH based on applying the indicated PUCCH format. Alternatively, in examples in which the UE 115-b transmits the HARQ bits over a PUSCH, the UE 115-b may multiplex the HARQ bits with a data transmission that is also sent over the PUSCH. In some examples, the UE 115-b may transmit HARQ bits corresponding to the requested one or more HARQ process identifiers. In some examples, transmitting the one or more HARQ bits may include transmitting signaling that indicates the one or more HARQ bits. For example, the one or more HARQ bits may be encoded, encrypted, multiplexed, or otherwise modified to generate UCI, and the UE 115-b may transmit the UCI indicating the one or more HARQ bits.

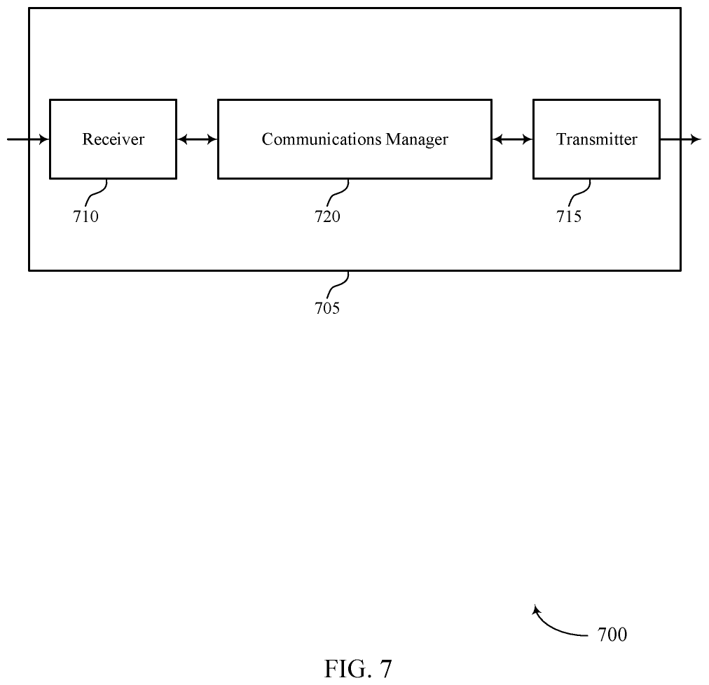

FIG. 7 shows a block diagram 700 of a device 705 that supports techniques for transmitting a scheduling request for pending HARQ bits in accordance with aspects of the present disclosure. The device 705 may be an example of aspects of a UE 115 as described herein. The device 705 may include a receiver 710, a transmitter 715, and a communications manager 720. The device 705 may also include at least one processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for transmitting a scheduling request for pending HARQ bits). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for transmitting a scheduling request for pending HARQ bits). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for transmitting a scheduling request for pending HARQ bits as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory).

Additionally, or alternatively, in some examples, the communications manager 720, the receiver 710, the transmitter 715, or various combinations or components thereof may be implemented in code (e.g., as communications management software) executed by at least one processor. If implemented in code executed by at least one processor, the functions of the communications manager 720, the receiver 710, the transmitter 715, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. For example, the communications manager 720 may be configured as or otherwise support a means for storing, at the UE, one or more HARQ bits associated with one or more HARQ process identifiers of the UE. The communications manager 720 may be configured as or otherwise support a means for transmitting a scheduling request associated with the one or more HARQ bits based on a quantity of the one or more HARQ bits. The communications manager 720 may be configured as or otherwise support a means for receiving, responsive to the scheduling request, control signaling indicating an uplink resource allocation for a transmission of the one or more HARQ bits. The communications manager 720 may be configured as or otherwise support a means for transmitting the one or more HARQ bits over the uplink resource allocation.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced processing, reduced power consumption, and more efficient utilization of communication resources.

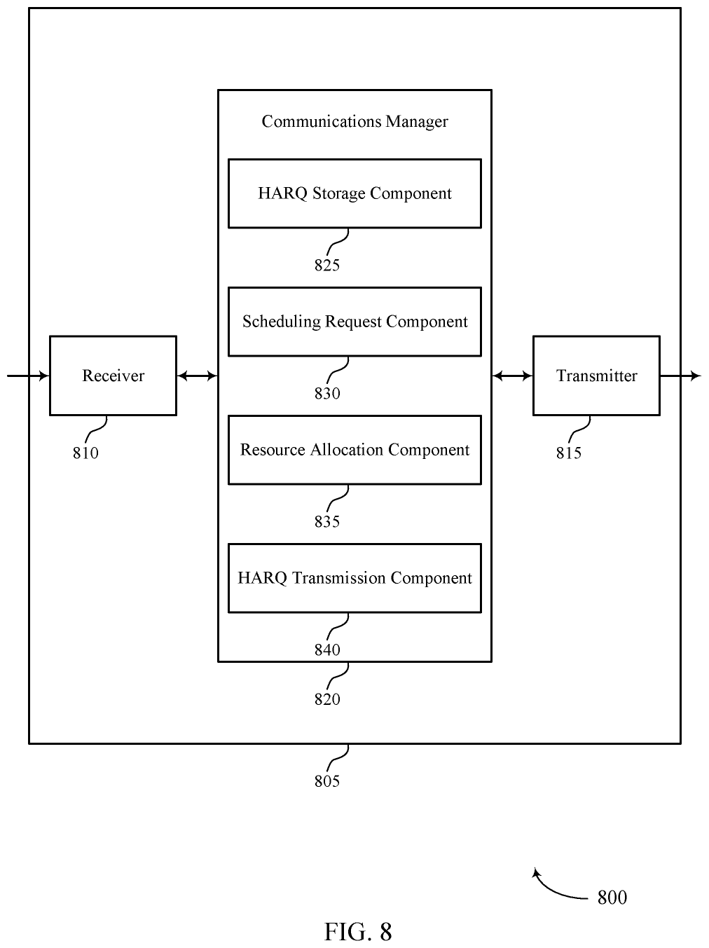

FIG. 8 shows a block diagram 800 of a device 805 that supports techniques for transmitting a scheduling request for pending HARQ bits in accordance with aspects of the present disclosure. The device 805 may be an example of aspects of a device 705 or a UE 115 as described herein. The device 805 may include a receiver 810, a transmitter 815, and a communications manager 820. The device 805 may also include at least one processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for transmitting a scheduling request for pending HARQ bits). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for transmitting a scheduling request for pending HARQ bits). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for transmitting a scheduling request for pending HARQ bits as described herein. For example, the communications manager 820 may include an HARQ storage component 825, a scheduling request component 830, a resource allocation component 835, an HARQ transmission component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. The HARQ storage component 825 may be configured as or otherwise support a means for storing, at the UE, one or more HARQ bits associated with one or more HARQ process identifiers of the UE. The scheduling request component 830 may be configured as or otherwise support a means for transmitting a scheduling request associated with the one or more HARQ bits based on a quantity of the one or more HARQ bits. The resource allocation component 835 may be configured as or otherwise support a means for receiving, responsive to the scheduling request, control signaling indicating an uplink resource allocation for a transmission of the one or more HARQ bits. The HARQ transmission component 840 may be configured as or otherwise support a means for transmitting the one or more HARQ bits over the uplink resource allocation.

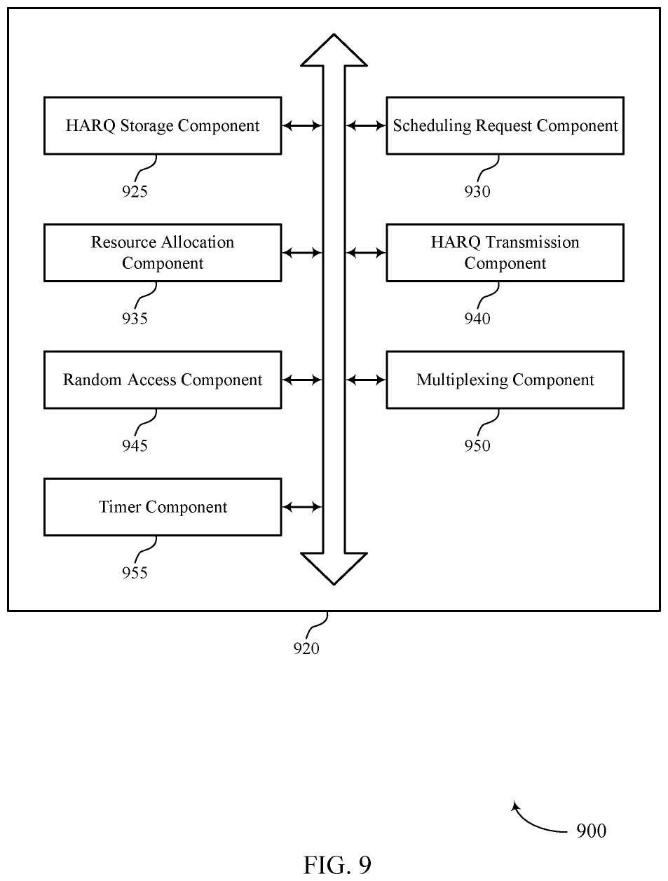

FIG. 9 shows a block diagram 900 of a communications manager 920 that supports techniques for transmitting a scheduling request for pending HARQ bits in accordance with aspects of the present disclosure. The communications manager 920 may be an example of aspects of a communications manager 720, a communications manager 820, or both, as described herein. The communications manager 920, or various components thereof, may be an example of means for performing various aspects of techniques for transmitting a scheduling request for pending HARQ bits as described herein. For example, the communications manager 920 may include an HARQ storage component 925, a scheduling request component 930, a resource allocation component 935, an HARQ transmission component 940, a random access component 945, a multiplexing component 950, a timer component 955, or any combination thereof. Each of these components may communicate, directly or indirectly, with one another (e.g., via one or more buses).

The communications manager 920 may support wireless communication at a UE in accordance with examples as disclosed herein. The HARQ storage component 925 may be configured as or otherwise support a means for storing, at the UE, one or more HARQ bits associated with one or more HARQ process identifiers of the UE. The scheduling request component 930 may be configured as or otherwise support a means for transmitting a scheduling request associated with the one or more HARQ bits based on a quantity of the one or more HARQ bits. The resource allocation component 935 may be configured as or otherwise support a means for receiving, responsive to the scheduling request, control signaling indicating an uplink resource allocation for a transmission of the one or more HARQ bits. The HARQ transmission component 940 may be configured as or otherwise support a means for transmitting the one or more HARQ bits over the uplink resource allocation.

In some examples, the scheduling request component 930 may trigger the scheduling request as a result of the quantity of the one or more HARQ bits stored at the UE satisfying a triggering condition, where the scheduling request is transmitted based on the triggering.

In some examples, to support transmitting the one or more HARQ bits over the uplink resource allocation, the HARQ transmission component 940 may be configured as or otherwise support a means for including the scheduling request associated with the one or more HARQ bits in UCI in accordance with a priority of scheduling requests associated with HARQ bits stored at the UE.

In some examples, the random access component 945 may be configured as or otherwise support a means for transmitting, to a network device, a random access message associated with a random access procedure based on the quantity of the one or more HARQ bits and the UE being in an unconnected state. In some examples, the random access component 945 may be configured as or otherwise support a means for establishing a connection with the network device as a result of the random access procedure, where transmitting the scheduling request associated with the one or more HARQ bits is based on establishing the connection with the network device.

In some examples, to support receiving the control signaling indicating the uplink resource allocation, the resource allocation component 935 may be configured as or otherwise support a means for receiving an indication of the one or more HARQ process identifiers for which feedback is requested, where transmitting the one or more HARQ bits associated with the one or more HARQ process identifiers is based on the indication of the one or more HARQ process identifiers for which feedback is requested.

In some examples, to support transmitting the scheduling request associated with the one or more HARQ bits, the scheduling request component 930 may be configured as or otherwise support a means for transmitting UCI including one or more bits indicating the scheduling request, the one or more bits having a location in the UCI that is dedicated for scheduling requests associated with HARQ bits stored at the UE.

In some examples, the location in the UCI includes a field dedicated for the scheduling requests associated with HARQ bits stored at the UE.

In some examples, the scheduling request component 930 may be configured as or otherwise support a means for receiving signaling indicating a configuration of resources for the scheduling request, where the resources are exclusively for scheduling requests associated with HARQ bits stored at the UE in accordance with the configuration, and where the scheduling request associated with the one or more HARQ bits is transmitted over the resources.

In some examples, the triggering condition includes a threshold quantity of HARQ bits stored at the UE.

In some examples, the one or more HARQ bits include at least one bit that is associated with NACK feedback. In some examples, the one or more HARQ bits satisfying the triggering condition is based on the one or more HARQ bits including the at least one bit that is associated with the NACK feedback.

In some examples, the uplink resource allocation includes a PUCCH, and to support receiving the control signaling indicating the uplink resource allocation, the resource allocation component 935 may be configured as or otherwise support a means for receiving an indication of a PUCCH format associated with the PUCCH, where the scheduling request associated with the one or more HARQ bits is transmitted using the PUCCH format.

In some examples, the uplink resource allocation includes a PUSCH, and the multiplexing component 950 may be configured as or otherwise support a means for multiplexing the one or more HARQ bits with a data transmission over the PUSCH, where transmitting the one or more HARQ bits over the PUSCH is based on the multiplexing.

In some examples, the multiplexing component 950 may be configured as or otherwise support a means for multiplexing the scheduling request associated with the one or more HARQ bits with one or more other feedback bits over a PUCCH based on applying an identifier-specific phase shift, where transmitting the scheduling request associated with the one or more HARQ bits is based on the multiplexing.

In some examples, the timer component 955 may be configured as or otherwise support a means for starting a timer as a result of transmitting the scheduling request associated with the one or more HARQ bits. In some examples, the scheduling request component 930 may be configured as or otherwise support a means for refraining from transmitting another scheduling request associated with HARQ bits stored at the UE for a duration of the timer.

In some examples, the HARQ transmission component 940 may be configured as or otherwise support a means for failing to transmit the one or more HARQ bits via previous UCI signaling based on one or more of a slot format change, an insufficiency of resources, or a cancellation indication. In some examples, the HARQ storage component 925 may be configured as or otherwise support a means for deferring the one or more HARQ bits for later UCI signaling, where storing the one or more HARQ bits at the UE is based on the deferring.

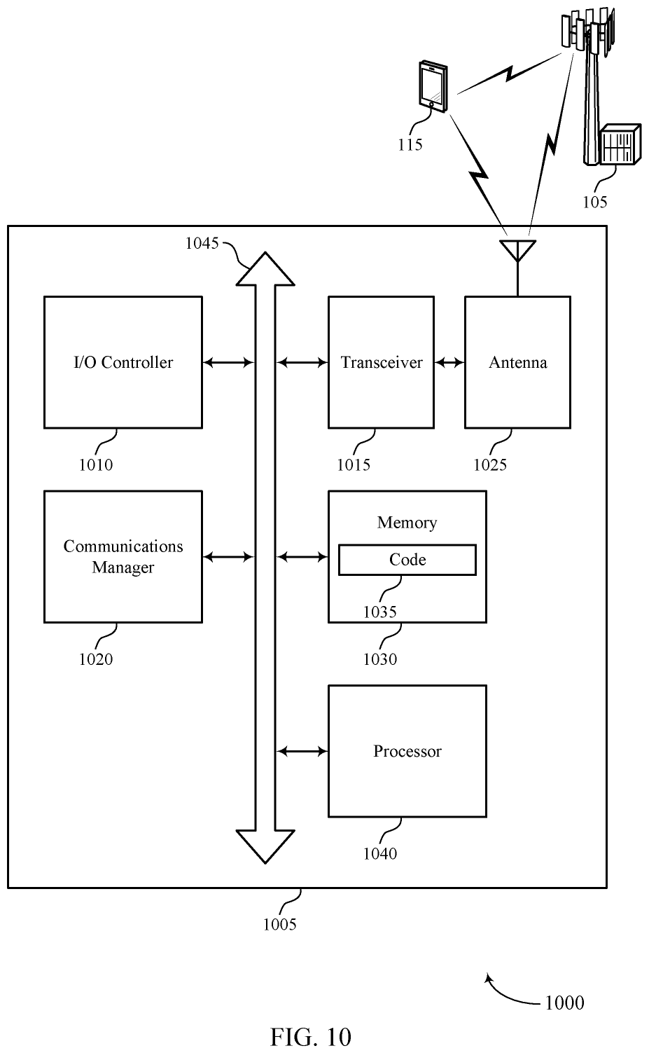

FIG. 10 shows a diagram of a system 1000 including a device 1005 that supports techniques for transmitting a scheduling request for pending HARQ bits in accordance with aspects of the present disclosure. The device 1005 may be an example of or include the components of a device 705, a device 805, or a UE 115 as described herein. The device 1005 may communicate wirelessly with one or more network devices (e.g., base stations 105 or other network entities), UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for transmitting a scheduling request for pending HARQ bits). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for storing, at the UE, one or more HARQ bits associated with one or more HARQ process identifiers of the UE. The communications manager 1020 may be configured as or otherwise support a means for transmitting a scheduling request associated with the one or more HARQ bits based on a quantity of the one or more HARQ bits. The communications manager 1020 may be configured as or otherwise support a means for receiving, responsive to the scheduling request, control signaling indicating an uplink resource allocation for a transmission of the one or more HARQ bits. The communications manager 1020 may be configured as or otherwise support a means for transmitting the one or more HARQ bits over the uplink resource allocation.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for transmitting a scheduling request for pending HARQ bits as described herein, or the processor 1040 and the memory 1030 may be otherwise configured to perform or support such operations.

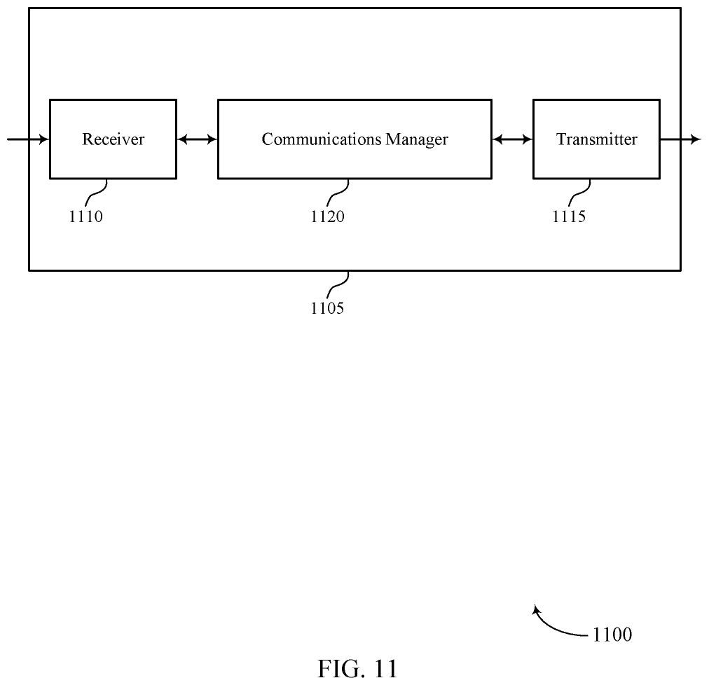

FIG. 11 shows a block diagram 1100 of a device 1105 that supports techniques for transmitting a scheduling request for pending HARQ bits in accordance with aspects of the present disclosure. The device 1105 may be an example of aspects of a network device, such as a base station 105 or another network entity, as described herein. The device 1105 may include a receiver 1110, a transmitter 1115, and a communications manager 1120. The device 1105 may also include at least one processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for transmitting a scheduling request for pending HARQ bits). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for transmitting a scheduling request for pending HARQ bits). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of techniques for transmitting a scheduling request for pending HARQ bits as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory).

Additionally or alternatively, in some examples, the communications manager 1120, the receiver 1110, the transmitter 1115, or various combinations or components thereof may be implemented in code (e.g., as communications management software) executed by at least one processor. If implemented in code executed by at least one processor, the functions of the communications manager 1120, the receiver 1110, the transmitter 1115, or various combinations or components thereof may be performed by a general-purpose processor, a DSP, a CPU, a GPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication in accordance with examples as disclosed herein. For example, the communications manager 1120 may be configured as or otherwise support a means for receiving a scheduling request associated with one or more HARQ bits for a UE (e.g., stored at the UE) based on a quantity of the one or more HARQ bits, the one or more HARQ bits being associated with one or more HARQ process identifiers of the UE. The communications manager 1120 may be configured as or otherwise support a means for transmitting, responsive to the scheduling request, control signaling indicating an uplink resource allocation for a transmission of the one or more HARQ bits. The communications manager 1120 may be configured as or otherwise support a means for receiving the one or more HARQ bits over the uplink resource allocation.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced processing, reduced power consumption, and more efficient utilization of communication resources.

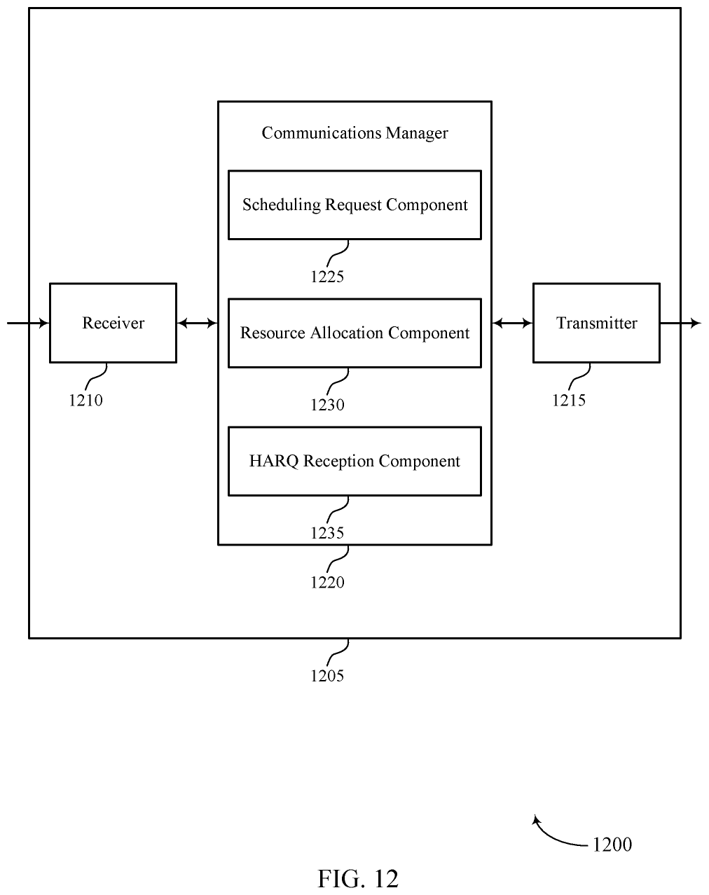

FIG. 12 shows a block diagram 1200 of a device 1205 that supports techniques for transmitting a scheduling request for pending HARQ bits in accordance with aspects of the present disclosure. The device 1205 may be an example of aspects of a device 1105 or a network device (e.g., a base station 105 or other network entity) as described herein. The device 1205 may include a receiver 1210, a transmitter 1215, and a communications manager 1220. The device 1205 may also include at least one processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for transmitting a scheduling request for pending HARQ bits). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for transmitting a scheduling request for pending HARQ bits). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for transmitting a scheduling request for pending HARQ bits as described herein. For example, the communications manager 1220 may include a scheduling request component 1225, a resource allocation component 1230, an HARQ reception component 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication in accordance with examples as disclosed herein. The scheduling request component 1225 may be configured as or otherwise support a means for receiving a scheduling request associated with one or more HARQ bits for a UE (e.g., stored at the UE) based on a quantity of the one or more HARQ bits, the one or more HARQ bits being associated with one or more HARQ process identifiers of the UE. The resource allocation component 1230 may be configured as or otherwise support a means for transmitting, responsive to the scheduling request, control signaling indicating an uplink resource allocation for a transmission of the one or more HARQ bits. The HARQ reception component 1235 may be configured as or otherwise support a means for receiving the one or more HARQ bits over the uplink resource allocation.

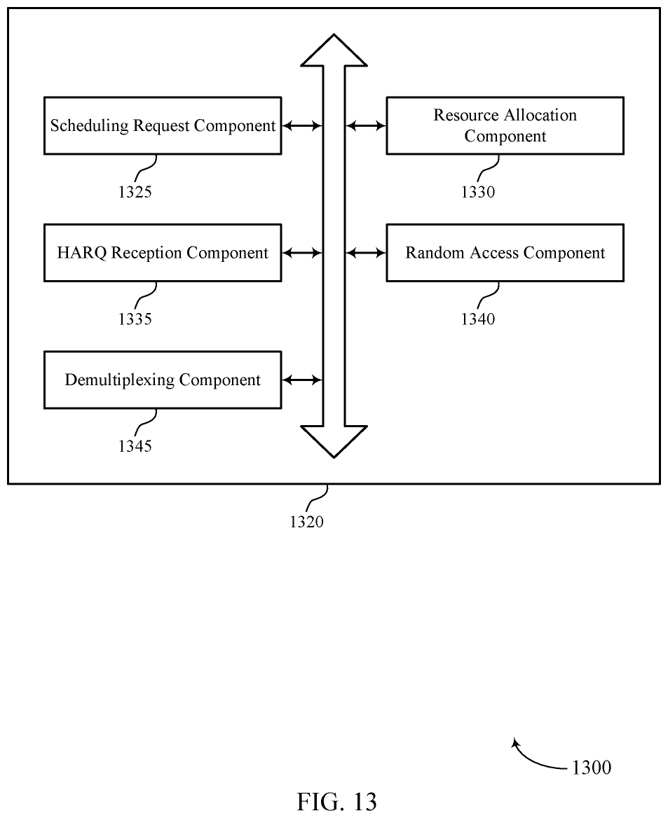

FIG. 13 shows a block diagram 1300 of a communications manager 1320 that supports techniques for transmitting a scheduling request for pending HARQ bits in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of techniques for transmitting a scheduling request for pending HARQ bits as described herein. For example, the communications manager 1320 may include a scheduling request component 1325, a resource allocation component 1330, an HARQ reception component 1335, a random access component 1340, a demultiplexing component 1345, or any combination thereof. Each of these components may communicate, directly or indirectly, with one another (e.g., via one or more buses).

The communications manager 1320 may support wireless communication at a network device in accordance with examples as disclosed herein. The scheduling request component 1325 may be configured as or otherwise support a means for receiving a scheduling request associated with one or more HARQ bits for a UE (e.g., stored at the UE) based on a quantity of the one or more HARQ bits, the one or more HARQ bits being associated with one or more HARQ process identifiers of the UE. The resource allocation component 1330 may be configured as or otherwise support a means for transmitting, responsive to the scheduling request, control signaling indicating an uplink resource allocation for a transmission of the one or more HARQ bits. The HARQ reception component 1335 may be configured as or otherwise support a means for receiving the one or more HARQ bits over the uplink resource allocation.

In some examples, to support receiving the scheduling request associated with the one or more HARQ bits, the scheduling request component 1325 may be configured as or otherwise support a means for receiving UCI including the scheduling request associated with the one or more HARQ bits in accordance with a priority of scheduling requests associated with HARQ bits stored at the UE.

In some examples, the random access component 1340 may be configured as or otherwise support a means for receiving a random access message associated with a random access procedure based on the quantity of the one or more HARQ bits for the UE and the UE being in an unconnected state. In some examples, the random access component 1340 may be configured as or otherwise support a means for establishing a connection with the UE as a result of the random access procedure, where receiving the scheduling request associated with the one or more HARQ bits is based on establishing the connection with the UE.

In some examples, to support transmitting the control signaling indicating the uplink resource allocation, the resource allocation component 1330 may be configured as or otherwise support a means for transmitting an indication of the one or more HARQ process identifiers for which feedback is requested, where receiving the one or more HARQ bits associated with the one or more HARQ process identifiers is based on the indication of the one or more HARQ process identifiers for which feedback is requested.

In some examples, to support receiving the scheduling request associated with the one or more HARQ bits, the scheduling request component 1325 may be configured as or otherwise support a means for receiving UCI including one or more bits indicating the scheduling request, the one or more bits having a location in the UCI that is dedicated for scheduling requests associated with HARQ bits stored at the UE.

In some examples, the location in the UCI includes a field dedicated for the scheduling requests associated with HARQ bits stored at the UE.

In some examples, the scheduling request component 1325 may be configured as or otherwise support a means for transmitting signaling indicating a configuration of resources for the scheduling request, where the resources are exclusively for scheduling requests associated with HARQ bits stored at the UE in accordance with the configuration, and where the scheduling request associated with the one or more HARQ bits is received over the resources.

In some examples, the scheduling request associated with the one or more HARQ bits is received based on the quantity of the one or more HARQ bits satisfying a threshold quantity of HARQ bits stored at the UE.

In some examples, the one or more HARQ bits includes at least one bit that is associated with NACK feedback. In some examples, the one or more HARQ bits satisfy a triggering condition based on the one or more HARQ bits including the at least one bit that is associated with the NACK feedback. In some examples, the scheduling request associated with the one or more HARQ bits is received based on the one or more HARQ bits satisfying the triggering condition.

In some examples, to support transmitting the control signaling indicating the uplink resource allocation, the resource allocation component 1330 may be configured as or otherwise support a means for transmitting an indication of a PUCCH format associated with the PUCCH, where the scheduling request associated with the one or more HARQ bits is received in accordance with the PUCCH format.

In some examples, the uplink resource allocation includes a PUSCH, and the demultiplexing component 1345 may be configured as or otherwise support a means for demultiplexing the one or more HARQ bits from a data transmission over the PUSCH, where receiving the one or more HARQ bits over the PUSCH is based on the demultiplexing.

In some examples, the demultiplexing component 1345 may be configured as or otherwise support a means for demultiplexing the scheduling request associated with the one or more HARQ bits from one or more other feedback bits over a PUCCH based on an identifier-specific phase shift, where receiving the scheduling request associated with the one or more HARQ bits is based on the demultiplexing.

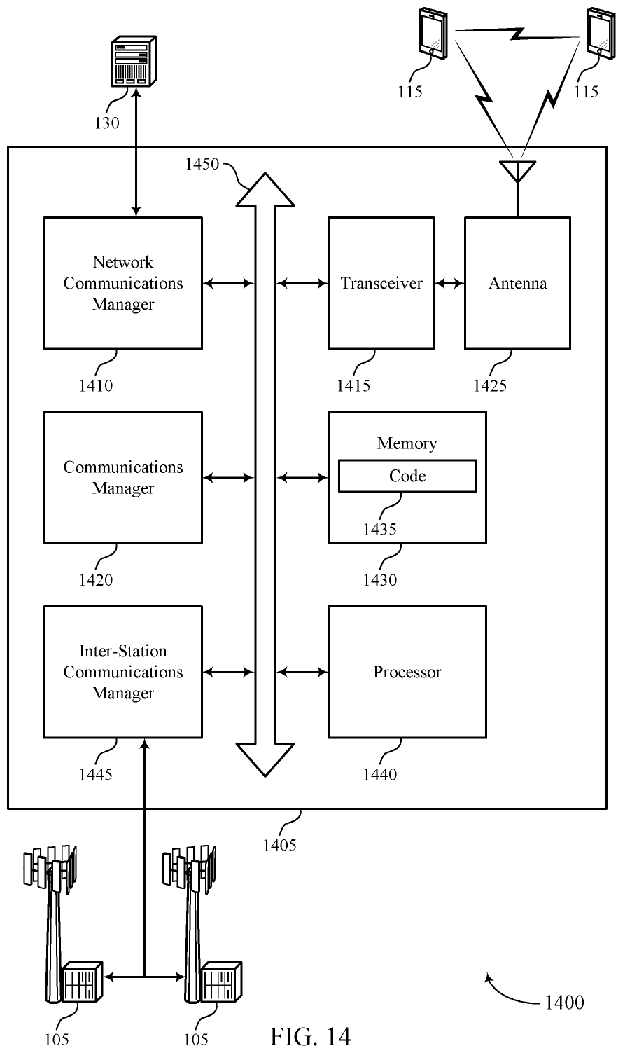

FIG. 14 shows a diagram of a system 1400 including a device 1405 that supports techniques for transmitting a scheduling request for pending HARQ bits in accordance with aspects of the present disclosure. The device 1405 may be an example of or include the components of a device 1105, a device 1205, or a network device (e.g., a base station 105 or another network entity) as described herein. The device 1405 may communicate wirelessly with one or more network devices (e.g., base stations 105), UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting techniques for transmitting a scheduling request for pending HARQ bits). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication in accordance with examples as disclosed herein. For example, the communications manager 1420 may be configured as or otherwise support a means for receiving a scheduling request associated with one or more HARQ bits for a UE (e.g., stored at the UE) based on a quantity of the one or more HARQ bits, the one or more HARQ bits being associated with one or more HARQ process identifiers of the UE. The communications manager 1420 may be configured as or otherwise support a means for transmitting, responsive to the scheduling request, control signaling indicating an uplink resource allocation for a transmission of the one or more HARQ bits. The communications manager 1420 may be configured as or otherwise support a means for receiving the one or more HARQ bits over the uplink resource allocation.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of techniques for transmitting a scheduling request for pending HARQ bits as described herein, or the processor 1440 and the memory 1430 may be otherwise configured to perform or support such operations.

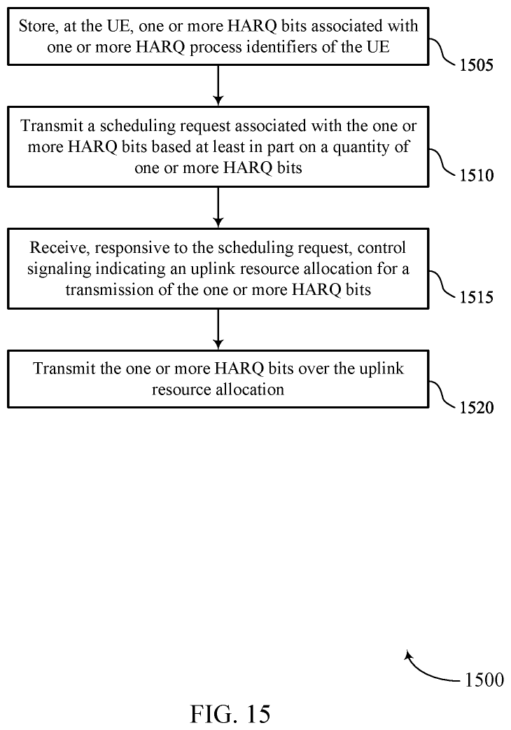

FIG. 15 shows a flowchart illustrating a method 1500 that supports techniques for transmitting a scheduling request for pending HARQ bits in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include storing, at the UE, one or more HARQ bits associated with one or more HARQ process identifiers of the UE. The operations of 1505 may be performed in accordance with examples as disclosed herein. In some examples, aspects of the operations of 1505 may be performed by an HARQ storage component 925 as described with reference to FIG. 9.

At 1510, the method may include transmitting a scheduling request associated with the one or more HARQ bits based at least in part on a quantity of the one or more HARQ bits. In some examples, the method may include transmitting a scheduling request associated with the one or more HARQ bits as a result of the quantity of HARQ bits stored at the UE satisfying a triggering condition. The operations of 1510 may be performed in accordance with examples as disclosed herein. In some examples, aspects of the operations of 1510 may be performed by a scheduling request component 930 as described with reference to FIG. 9.

At 1515, the method may include receiving, responsive to the scheduling request, control signaling indicating an uplink resource allocation for a transmission of the one or more HARQ bits. The operations of 1515 may be performed in accordance with examples as disclosed herein. In some examples, aspects of the operations of 1515 may be performed by a resource allocation component 935 as described with reference to FIG. 9.

At 1520, the method may include transmitting the one or more HARQ bits over the uplink resource allocation. The operations of 1520 may be performed in accordance with examples as disclosed herein. In some examples, aspects of the operations of 1520 may be performed by an HARQ transmission component 940 as described with reference to FIG. 9.

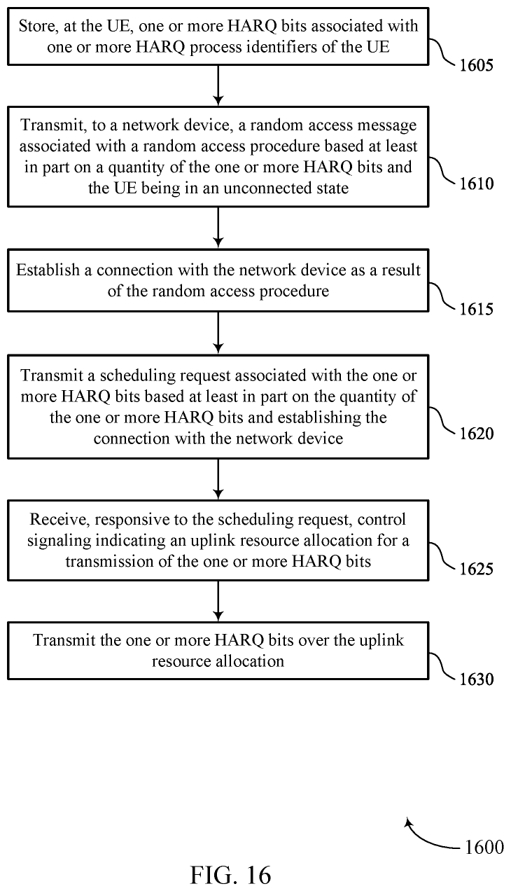

FIG. 16 shows a flowchart illustrating a method 1600 that supports techniques for transmitting a scheduling request for pending HARQ bits in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include storing, at the UE, one or more HARQ bits associated with one or more HARQ process identifiers of the UE. The operations of 1605 may be performed in accordance with examples as disclosed herein. In some examples, aspects of the operations of 1605 may be performed by an HARQ storage component 925 as described with reference to FIG. 9.

At 1610, the method may include transmitting, to a network device, a random access message associated with a random access procedure based at least in part on a quantity of the one or more HARQ bits and the UE being in an unconnected state. The operations of 1610 may be performed in accordance with examples as disclosed herein. In some examples, aspects of the operations of 1610 may be performed by a random access component 945 as described with reference to FIG. 9.

At 1615, the method may include establishing a connection with the network device as a result of the random access procedure. The operations of 1615 may be performed in accordance with examples as disclosed herein. In some examples, aspects of the operations of 1615 may be performed by a random access component 945 as described with reference to FIG. 9.

At 1620, the method may include transmitting a scheduling request associated with the one or more HARQ bits based at least in part on the quantity of the one or more HARQ bits and establishing the connection with the network device. The operations of 1620 may be performed in accordance with examples as disclosed herein. In some examples, aspects of the operations of 1620 may be performed by a scheduling request component 930 as described with reference to FIG. 9.

At 1625, the method may include receiving, responsive to the scheduling request, control signaling indicating an uplink resource allocation for a transmission of the one or more HARQ bits. The operations of 1625 may be performed in accordance with examples as disclosed herein. In some examples, aspects of the operations of 1625 may be performed by a resource allocation component 935 as described with reference to FIG. 9.

At 1630, the method may include transmitting the one or more HARQ bits over the uplink resource allocation. The operations of 1630 may be performed in accordance with examples as disclosed herein. In some examples, aspects of the operations of 1630 may be performed by an HARQ transmission component 940 as described with reference to FIG. 9.

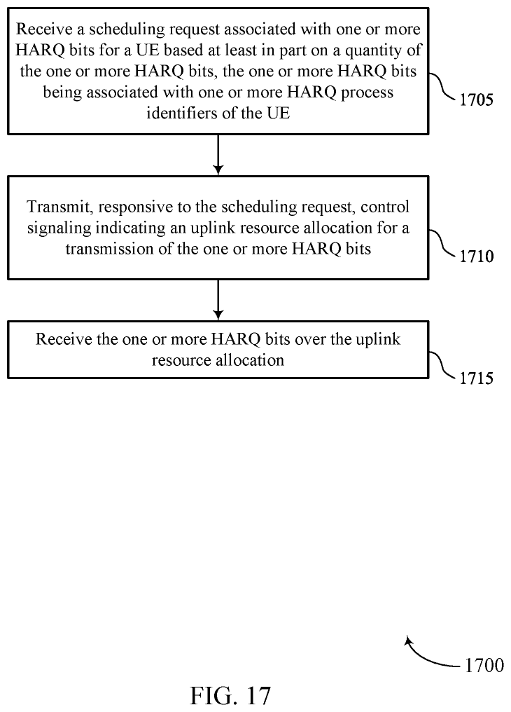

FIG. 17 shows a flowchart illustrating a method 1700 that supports techniques for transmitting a scheduling request for pending HARQ bits in accordance with aspects of the present disclosure. The operations of the method 1700 may be implemented by a network device (e.g., a base station or another network entity) or its components as described herein. For example, the operations of the method 1700 may be performed by a base station 105 as described with reference to FIGS. 1 through 6 and 11 through 14. In some examples, a network device may execute a set of instructions to control the functional elements of the network device to perform the described functions. Additionally or alternatively, the network device may perform aspects of the described functions using special-purpose hardware.

At 1705, the method may include receiving (e.g., from a UE) a scheduling request associated with one or more HARQ bits for the UE (e.g., stored at the UE) based at least in part on a quantity of the one or more HARQ bits, the one or more HARQ bits being associated with one or more HARQ process identifiers of the UE. In some examples, the method may include receiving the scheduling request associated with the one or more HARQ bits stored at the UE as a result of the one or more HARQ bits stored at the UE satisfying a triggering condition. The operations of 1705 may be performed in accordance with examples as disclosed herein. In some examples, aspects of the operations of 1705 may be performed by a scheduling request component 1325 as described with reference to FIG. 13.

At 1710, the method may include transmitting (e.g., to the UE), responsive to the scheduling request, control signaling indicating an uplink resource allocation for a transmission of the one or more HARQ bits. The operations of 1710 may be performed in accordance with examples as disclosed herein. In some examples, aspects of the operations of 1710 may be performed by a resource allocation component 1330 as described with reference to FIG. 13.

At 1715, the method may include receiving (e.g., from the UE) the one or more HARQ bits over the uplink resource allocation. The operations of 1715 may be performed in accordance with examples as disclosed herein. In some examples, aspects of the operations of 1715 may be performed by an HARQ reception component 1335 as described with reference to FIG. 13.

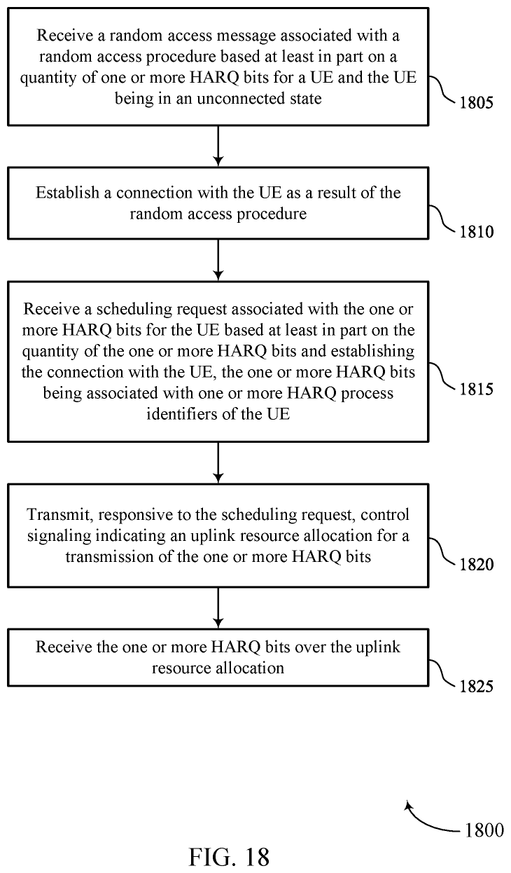

FIG. 18 shows a flowchart illustrating a method 1800 that supports techniques for transmitting a scheduling request for pending HARQ bits in accordance with aspects of the present disclosure. The operations of the method 1800 may be implemented by a network device (e.g., a base station or another network entity) or its components as described herein. For example, the operations of the method 1800 may be performed by a base station 105 as described with reference to FIGS. 1 through 6 and 11 through 14. In some examples, a network device may execute a set of instructions to control the functional elements of the network device to perform the described functions. Additionally or alternatively, the network device may perform aspects of the described functions using special-purpose hardware.

At 1805, the method may include receiving a random access message associated with a random access procedure based at least in part on a quantity of one or more HARQ bits for a UE and the UE being in an unconnected state. The operations of 1805 may be performed in accordance with examples as disclosed herein. In some examples, aspects of the operations of 1805 may be performed by a random access component 1340 as described with reference to FIG. 13.

At 1810, the method may include establishing a connection with the UE as a result of the random access procedure. The operations of 1810 may be performed in accordance with examples as disclosed herein. In some examples, aspects of the operations of 1810 may be performed by a random access component 1340 as described with reference to FIG. 13.

At 1815, the method may include receiving a scheduling request associated with the one or more HARQ bits for the UE based at least in part on the quantity of the one or more HARQ bits and establishing the connection with the UE, the one or more HARQ bits being associated with one or more HARQ process identifiers of the UE. The operations of 1815 may be performed in accordance with examples as disclosed herein. In some examples, aspects of the operations of 1815 may be performed by a scheduling request component 1325 as described with reference to FIG. 13.

At 1820, the method may include transmitting, responsive to the scheduling request, control signaling indicating an uplink resource allocation for a transmission of the one or more HARQ bits. The operations of 1820 may be performed in accordance with examples as disclosed herein. In some examples, aspects of the operations of 1820 may be performed by a resource allocation component 1330 as described with reference to FIG. 13.

At 1825, the method may include receiving the one or more HARQ bits over the uplink resource allocation. The operations of 1825 may be performed in accordance with examples as disclosed herein. In some examples, aspects of the operations of 1825 may be performed by an HARQ reception component 1335 as described with reference to FIG. 13.

The following provides an overview of aspects of the present disclosure:

Aspect 1: A method for wireless communication at a UE, comprising: storing, at the UE, one or more HARQ bits associated with one or more HARQ process identifiers of the UE; transmitting a scheduling request associated with the one or more HARQ bits based at least in part on a quantity of the one or more HARQ bits; receiving, responsive to the scheduling request, control signaling indicating an uplink resource allocation for a transmission of the one or more HARQ bits; and transmitting the one or more HARQ bits over the uplink resource allocation.

Aspect 2: The method of aspect 1, further comprising: triggering the scheduling request as a result of the quantity of the one or more HARQ bits stored at the UE satisfying a triggering condition, wherein the scheduling request is transmitted based at least in part on the triggering.

Aspect 3: The method of aspect 2, wherein the triggering condition comprises a threshold quantity of HARQ bits stored at the UE.

Aspect 4: The method of any of aspects 2 through 3, wherein: the one or more HARQ bits include at least one bit that is associated with NACK feedback; and the one or more HARQ bits satisfying the triggering condition is based at least in part on the one or more HARQ bits including the at least one bit that is associated with the NACK feedback.

Aspect 5: The method of any of aspects 1 through 4, wherein transmitting the one or more HARQ bits over the uplink resource allocation comprises: including the scheduling request associated with the one or more HARQ bits in UCI in accordance with a priority of scheduling requests associated with HARQ bits stored at the UE.

Aspect 6: The method of any of aspects 1 through 5, further comprising: transmitting, to a network device, a random access message associated with a random access procedure based at least in part on the quantity of the one or more HARQ bits and the UE being in an unconnected state; and establishing a connection with the network device as a result of the random access procedure, wherein transmitting the scheduling request associated with the one or more HARQ bits is based at least in part on establishing the connection with the network device.

Aspect 7: The method of any of aspects 1 through 6, wherein receiving the control signaling indicating the uplink resource allocation comprises: receiving an indication of the one or more HARQ process identifiers for which feedback is requested, wherein transmitting the one or more HARQ bits associated with the one or more HARQ process identifiers is based at least in part on the indication of the one or more HARQ process identifiers for which feedback is requested.

Aspect 8: The method of any of aspects 1 through 7, wherein transmitting the scheduling request associated with the one or more HARQ bits comprises: transmitting UCI including one or more bits indicating the scheduling request, the one or more bits having a location in the UCI that is dedicated for scheduling requests associated with HARQ bits stored at the UE.

Aspect 9: The method of aspect 8, wherein the location in the UCI includes a field dedicated for the scheduling requests associated with HARQ bits stored at the UE.

Aspect 10: The method of any of aspects 1 through 9, further comprising: receiving signaling indicating a configuration of resources for the scheduling request, wherein the resources are exclusively for scheduling requests associated with HARQ bits stored at the UE in accordance with the configuration, and wherein the scheduling request associated with the one or more HARQ bits is transmitted over the resources.

Aspect 11: The method of any of aspects 1 through 10, wherein the uplink resource allocation comprises a PUCCH, and wherein receiving the control signaling indicating the uplink resource allocation comprises: receiving an indication of a PUCCH format associated with the PUCCH, wherein the scheduling request associated with the one or more HARQ bits is transmitted using the PUCCH format.

Aspect 12: The method of any of aspects 1 through 10, wherein the uplink resource allocation comprises a PUSCH, the method further comprising: multiplexing the one or more HARQ bits with a data transmission over the PUSCH, wherein transmitting the one or more HARQ bits over the PUSCH is based at least in part on the multiplexing.

Aspect 13: The method of any of aspects 1 through 12, further comprising: multiplexing the scheduling request associated with the one or more HARQ bits with one or more other feedback bits over a PUCCH based at least in part on applying an identifier-specific phase shift, wherein transmitting the scheduling request associated with the one or more HARQ bits is based at least in part on the multiplexing.

Aspect 14: The method of any of aspects 1 through 13, further comprising: starting a timer as a result of transmitting the scheduling request associated with the one or more HARQ bits; and refraining from transmitting another scheduling request associated with HARQ bits stored at the UE for a duration of the timer.

Aspect 15: The method of any of aspects 1 through 14, further comprising: failing to transmit the one or more HARQ bits via previous UCI signaling based at least in part on one or more of a slot format change, an insufficiency of resources, or a cancellation indication; and deferring the one or more HARQ bits for later UCI signaling, wherein storing the one or more HARQ bits at the UE is based at least in part on the deferring.

Aspect 16: A method for wireless communication, comprising: receiving a scheduling request associated with one or more HARQ bits for a UE based at least in part on a quantity of the one or more HARQ bits, the one or more HARQ bits being associated with one or more HARQ process identifiers of the UE; transmitting, responsive to the scheduling request, control signaling indicating an uplink resource allocation for a transmission of the one or more HARQ bits; and receiving the one or more HARQ bits over the uplink resource allocation.

Aspect 17: The method of aspect 16, wherein receiving the scheduling request associated with the number of HARQ bits comprises: receiving UCI including the scheduling request associated with the one or more HARQ bits in accordance with a priority of scheduling requests associated with HARQ bits stored at the UE.

Aspect 18: The method of any of aspects 16 through 17, further comprising: receiving a random access message associated with a random access procedure based at least in part on the quantity of the one or more HARQ bits for the UE and the UE being in an unconnected state; and establishing a connection with the UE as a result of the random access procedure, wherein receiving the scheduling request associated with the one or more HARQ bits is based at least in part on establishing the connection with the UE.

Aspect 19: The method of any of aspects 16 through 18, wherein transmitting the control signaling indicating the uplink resource allocation comprises: transmitting an indication of the one or more HARQ process identifiers for which feedback is requested, wherein receiving the one or more HARQ bits associated with the one or more HARQ process identifiers is based at least in part on the indication of the one or more HARQ process identifiers for which feedback is requested.

Aspect 20: The method of any of aspects 16 through 19, wherein receiving the scheduling request associated with the one or more HARQ bits comprises: receiving UCI including one or more bits indicating the scheduling request, the one or more bits having a location in the UCI that is dedicated for scheduling requests associated with HARQ bits stored at the UE.

Aspect 21: The method of aspect 20, wherein the location in the UCI comprises a field dedicated for the scheduling requests associated with HARQ bits stored at the UE.

Aspect 22: The method of any of aspects 16 through 21, further comprising: transmitting signaling indicating a configuration of resources for the scheduling request, wherein the resources are exclusively for scheduling requests associated with HARQ bits stored at the UE in accordance with the configuration, and wherein the scheduling request associated with the one or more HARQ bits is received over the resources.

Aspect 23: The method of any of aspects 16 through 22, wherein the scheduling request associated with the one or more HARQ bits is received based at least in part on the quantity of the one or more HARQ bits satisfying a threshold quantity of HARQ bits stored at the UE.

Aspect 24: The method of any of aspects 16 through 23, wherein: the one or more HARQ bits include at least one bit that is associated with NACK feedback; the one or more HARQ bits satisfy a triggering condition based at least in part on the one or more HARQ bits including the at least one bit that is associated with the NACK feedback; and the scheduling request associated with the one or more HARQ bits is received based at least in part on the one or more HARQ bits satisfying the triggering condition.

Aspect 25: The method of any of aspects 16 through 24, wherein the uplink resource allocation comprises a PUCCH, and wherein transmitting the control signaling indicating the uplink resource allocation further comprises: transmitting an indication of a PUCCH format associated with the PUCCH, wherein the scheduling request associated with the one or more HARQ bits is received in accordance with the PUCCH format.

Aspect 26: The method of any of aspects 16 through 24, wherein the uplink resource allocation comprises a PUSCH, the method further comprising: demultiplexing the one or more HARQ bits from a data transmission over the PUSCH, wherein receiving the one or more HARQ bits over the PUSCH is based at least in part on the demultiplexing.

Aspect 27: The method of any of aspects 16 through 26, further comprising: demultiplexing the scheduling request associated with the one or more HARQ bits from one or more other feedback bits over a PUCCH based at least in part on an identifier-specific phase shift, wherein receiving the scheduling request associated with the one or more HARQ bits is based at least in part on the demultiplexing.

Aspect 28: An apparatus for wireless communication at a UE, comprising: at least one processor; and memory coupled with the at least one processor, the memory storing instructions executable by the at least one processor to cause the UE to perform a method of any of aspects 1 through 15.

Aspect 29: An apparatus for wireless communication at a UE, comprising at least one means for performing a method of any of aspects 1 through 15.

Aspect 30: A non-transitory computer-readable medium storing code for wireless communication at a UE, the code comprising instructions executable by at least one processor to perform a method of any of aspects 1 through 15.

Aspect 31: An apparatus for wireless communication at a network device, comprising: at least one processor; and memory coupled with the at least one processor, the memory storing instructions executable by the at least one processor to cause the network device to perform a method of any of aspects 16 through 27.

Aspect 32: An apparatus for wireless communication, comprising at least one means for performing a method of any of aspects 16 through 27.

Aspect 33: A non-transitory computer-readable medium storing code for wireless communication, the code comprising instructions executable by at least one processor to perform a method of any of aspects 16 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, functions, or any combination thereof, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), or ascertaining. Also, “determining” can include receiving (such as receiving information) or accessing (such as accessing data in a memory). Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
store, at the UE, one or more hybrid automatic repeat request (HARQ) bits associated with one or more HARQ process identifiers of the UE;
transmit a scheduling request associated with the one or more HARQ bits based at least in part on a quantity of the one or more HARQ bits;
receive, responsive to the scheduling request, control signaling indicating an uplink resource allocation for a transmission of the one or more HARQ bits; and
transmit the one or more HARQ bits over the uplink resource allocation.

2. The apparatus of claim 1, wherein the instructions are further executable by the at least one processor to cause the UE to:
trigger the scheduling request as a result of the quantity of the one or more HARQ bits stored at the UE satisfying a triggering condition, wherein the scheduling request is transmitted based at least in part on the triggering.

3. The apparatus of claim 2, wherein the triggering condition comprises a threshold quantity of HARQ bits stored at the UE.

4. The apparatus of claim 2, wherein:
the one or more HARQ bits comprise at least one bit that is associated with negative acknowledgement feedback; and
the one or more HARQ bits satisfying the triggering condition is based at least in part on the one or more HARQ bits comprising the at least one bit that is associated with the negative acknowledgement feedback.

5. The apparatus of claim 1, wherein the instructions to transmit the one or more HARQ bits over the uplink resource allocation are executable by the at least one processor to cause the UE to:
include the scheduling request associated with the one or more HARQ bits in uplink control information in accordance with a priority of scheduling requests associated with HARQ bits stored at the UE.

6. The apparatus of claim 1, wherein the instructions are further executable by the at least one processor to cause the UE to:
transmit, to a network device, a random access message associated with a random access procedure based at least in part on the quantity of the one or more HARQ bits and the UE being in an unconnected state; and
establish a connection with the network device as a result of the random access procedure, wherein transmitting the scheduling request associated with the one or more HARQ bits is based at least in part on establishing the connection with the network device.

7. The apparatus of claim 1, wherein the instructions to receive the control signaling indicating the uplink resource allocation are executable by the at least one processor to cause the UE to:
receive an indication of the one or more HARQ process identifiers for which feedback is requested, wherein transmitting the one or more HARQ bits associated with the one or more HARQ process identifiers is based at least in part on the indication of the one or more HARQ process identifiers for which feedback is requested.

8. The apparatus of claim 1, wherein the instructions to transmit the scheduling request associated with the one or more HARQ bits are executable by the at least one processor to cause the UE to:
transmit uplink control information comprising one or more bits indicating the scheduling request, the one or more bits having a location in the uplink control information that is dedicated for scheduling requests associated with HARQ bits stored at the UE.

9. The apparatus of claim 8, wherein the location in the uplink control information comprises a field dedicated for the scheduling requests associated with HARQ bits stored at the UE.

10. The apparatus of claim 1, wherein the instructions are further executable by the at least one processor to cause the UE to:
receive signaling indicating a configuration of resources for the scheduling request, wherein the resources are exclusively for scheduling requests associated with HARQ bits stored at the UE in accordance with the configuration, and wherein the scheduling request associated with the one or more HARQ bits is transmitted over the resources.

11. The apparatus of claim 1, wherein the uplink resource allocation comprises a physical uplink control channel, and wherein the instructions to receive the control signaling indicating the uplink resource allocation are executable by the at least one processor to cause the UE to:
receive an indication of a physical uplink control channel format associated with the physical uplink control channel, wherein the scheduling request associated with the one or more HARQ bits is transmitted using the physical uplink control channel format.

12. The apparatus of claim 1, wherein the uplink resource allocation comprises a physical uplink shared channel, and the instructions are further executable by the at least one processor to cause the UE to:
multiplex the one or more HARQ bits with a data transmission over the physical uplink shared channel, wherein transmitting the one or more HARQ bits over the physical uplink shared channel is based at least in part on the multiplexing.

13. The apparatus of claim 1, wherein the instructions are further executable by the at least one processor to cause the UE to:
multiplex the scheduling request associated with the one or more HARQ bits with one or more other feedback bits over a physical uplink control channel based at least in part on applying an identifier-specific phase shift, wherein transmitting the scheduling request associated with the one or more HARQ bits is based at least in part on the multiplexing.

14. The apparatus of claim 1, wherein the instructions are further executable by the at least one processor to cause the UE to:
start a timer as a result of transmitting the scheduling request associated with the one or more HARQ bits; and
refrain from transmitting another scheduling request associated with HARQ bits stored at the UE for a duration of the timer.

15. The apparatus of claim 1, wherein the instructions are further executable by the at least one processor to cause the UE to:
fail to transmit the one or more HARQ bits via previous uplink control information signaling based at least in part on one or more of a slot format change, an insufficiency of resources, or a cancellation indication; and
defer the one or more HARQ bits for later uplink control information signaling, wherein storing the one or more HARQ bits at the UE is based at least in part on the deferring.

16. An apparatus for wireless communication at a network device, comprising:
at least one processor; and
memory coupled with the at least one processor, the memory storing instructions executable by the at least one processor to cause the network device to:
receive a scheduling request associated with one or more hybrid automatic repeat request (HARQ) bits for a user equipment (UE) based at least in part on a quantity of the one or more HARQ bits, the one or more HARQ bits being associated with one or more HARQ process identifiers of the UE;
transmit, responsive to the scheduling request, control signaling indicating an uplink resource allocation for a transmission of the one or more HARQ bits; and
receive the one or more HARQ bits over the uplink resource allocation.

17. The apparatus of claim 16, wherein the instructions to receive the scheduling request associated with the one or more HARQ bits are executable by the at least one processor to cause the network device to:
receive uplink control information comprising the scheduling request associated with the one or more HARQ bits in accordance with a priority of scheduling requests associated with HARQ bits stored at the UE.

18. The apparatus of claim 16, wherein the instructions are further executable by the at least one processor to cause the network device to:
receive a random access message associated with a random access procedure based at least in part on the quantity of the one or more HARQ bits for the UE and the UE being in an unconnected state; and
establish a connection with the UE as a result of the random access procedure, wherein receiving the scheduling request associated with the one or more HARQ bits is based at least in part on establishing the connection with the UE.

19. The apparatus of claim 16, wherein the instructions to transmit the control signaling indicating the uplink resource allocation are executable by the at least one processor to cause the network device to:
transmit an indication of the one or more HARQ process identifiers for which feedback is requested, wherein receiving the one or more HARQ bits associated with the one or more HARQ process identifiers is based at least in part on the indication of the one or more HARQ process identifiers for which feedback is requested.

20. The apparatus of claim 16, wherein the instructions to receive the scheduling request associated with the one or more HARQ bits are executable by the at least one processor to cause the network device to:
receive uplink control information comprising one or more bits indicating the scheduling request, the one or more bits having a location in the uplink control information that is dedicated for scheduling requests associated with HARQ bits stored at the UE.

21. The apparatus of claim 20, wherein the location in the uplink control information comprises a field dedicated for the scheduling requests associated with HARQ bits stored at the UE.

22. The apparatus of claim 16, wherein the instructions are further executable by the at least one processor to cause the network device to:
transmit signaling indicating a configuration of resources for the scheduling request, wherein the resources are exclusively for scheduling requests associated with HARQ bits stored at the UE in accordance with the configuration, and wherein the scheduling request associated with the one or more HARQ bits is received over the resources.

23. The apparatus of claim 16, wherein the scheduling request associated with the one or more HARQ bits is received based at least in part on the quantity of the one or more HARQ bits satisfying a threshold quantity of HARQ bits stored at the UE.

24. The apparatus of claim 16, wherein:
the one or more HARQ bits comprise at least one bit that is associated with negative acknowledgement feedback;
the one or more HARQ bits satisfy a triggering condition based at least in part on the one or more HARQ bits comprising the at least one bit that is associated with the negative acknowledgement feedback; and
the scheduling request associated with the one or more HARQ bits is received based at least in part on the one or more HARQ bits satisfying the triggering condition.

25. The apparatus of claim 16, wherein the uplink resource allocation comprises a physical uplink control channel, and wherein the instructions to transmit the control signaling indicating the uplink resource allocation are executable by the at least one processor to cause the network device to:
transmit an indication of a physical uplink control channel format associated with the physical uplink control channel, wherein the scheduling request associated with the one or more HARQ bits is received in accordance with the physical uplink control channel format.

26. The apparatus of claim 16, wherein the uplink resource allocation comprises a physical uplink shared channel, and wherein the instructions are further executable by the at least one processor to cause the network device to:
demultiplex the one or more HARQ bits from a data transmission over the physical uplink shared channel, wherein receiving the one or more HARQ bits over the physical uplink shared channel is based at least in part on the demultiplexing.

27. The apparatus of claim 16, wherein the instructions are further executable by the at least one processor to cause the network device to:
demultiplex the scheduling request associated with the one or more HARQ bits from one or more other feedback bits over a physical uplink control channel based at least in part on an identifier-specific phase shift, wherein receiving the scheduling request associated with the one or more HARQ bits is based at least in part on the demultiplexing.

28. A method for wireless communication at a user equipment (UE), comprising:
storing, at the UE, one or more hybrid automatic repeat request (HARQ) bits associated with one or more HARQ process identifiers of the UE;
transmitting a scheduling request associated with the one or more HARQ bits based at least in part on a quantity of the one or more HARQ bits;
receiving, responsive to the scheduling request, control signaling indicating an uplink resource allocation for a transmission of the one or more HARQ bits; and
transmitting the one or more HARQ bits over the uplink resource allocation.

29. The method of claim 28, further comprising:
triggering the scheduling request as a result of the quantity of the one or more HARQ bits stored at the UE satisfying a triggering condition, wherein the scheduling request is transmitted based at least in part on the triggering.

30. A method for wireless communication, comprising:
receiving a scheduling request associated with one or more hybrid automatic repeat request (HARQ) bits for a user equipment (UE) based at least in part on a quantity of the one or more HARQ bits, the one or more HARQ bits being associated with one or more HARQ process identifiers of the UE;
transmitting, responsive to the scheduling request, control signaling indicating an uplink resource allocation for a transmission of the one or more HARQ bits; and
receiving the one or more HARQ bits over the uplink resource allocation.
